(19) United States
(12) Patent Application Publication
(10) Pub. No.: US 2025/0030919 A1
(43) Pub. Date: Jan. 23, 2025

(54) IMAGE DISPLAY APPARATUS AND SERVER

(71) Applicant: LG ELECTRONICS INC., Seoul (KR)

(72) Inventors: Changsun LEEM, Seoul (KR); Jeonghyu YANG, Seoul (KR); Gohee CHOI, Seoul (KR); Jongchan KIM, Seoul (KR)

(73) Assignee: LG ELECTRONICS INC., Seoul (KR)

(21) Appl. No.: 18/278,127

(22) PCT Filed: Nov. 11, 2022
(86) PCT No.: PCT/KR2022/017715

§ 371 Date: Aug. 21, 2023

(30) Foreign Application Priority Data
Feb. 23, 2022 (KR) 10-2022-0023793

(51) Int. Cl. H04N 21/462; H04N 21/4223; H04N 21/458; H04N 21/466; H04N 21/4788

(52) U.S. Cl. CPC H04N 21/462; H04N 21/4223; H04N 21/458; H04N 21/4667; H04N 21/4788

(57) ABSTRACT

The present disclosure relates to an image display apparatus and a server. The image display apparatus according to an embodiment of the present disclosure includes: a display; a content receiving device configured to receive real-time content or non-real-time content from an external server or a content provider; and a signal processing device configured to generate a program guide by combining the real-time content and the non-real-time content which are received by the content receiving device, and to display the generated program guide on the display or display the content based on the generated program guide. Accordingly, a custom program guide including the real-time content and the non-real-time content may be provided.

### BACKGROUND

### 1. Field

The present disclosure relates to an image display apparatus and a server, and more particularly to an image display apparatus capable of providing a custom program guide including real-time content and non-real-time content, and a server.

### 2. Description of the Related Art

The image display apparatus is a device that displays videos viewed by users.

For example, the image display apparatus may receive a broadcast signal and display a broadcast video.

In another example, the image display apparatus may receive a streaming video signal from an external server and display a streaming video.

As described above, the image display apparatus may display content from various video sources, and with the development of technology, the number of video content that can be displayed on the image display apparatus increases.

As an increasing number of video content can be displayed on the image display apparatus, research is conducted to provide a method of providing a program guide for user convenience and the like.

For example, if the image display apparatus receives a digital broadcast signal, the image display apparatus may generate and display an information electronic program guide by using an Electronic Program Guide included in the digital broadcast signal.

Korean Patent No. 10-0838800 (hereinafter referred to as “related art 1”) discloses a personal broadcasting service system and method which include registering subscription information of a transmission terminal and a reception terminal, performing an authentication procedure for the transmission terminal and the reception terminal, and transmitting Electronic Program Guide information and address information for a broadcasting service to the transmission terminal and the reception terminal.

However, related art 1 has a drawback in that the program guide is limited to the broadcasting service which is the real-time content, such that a program guide for Video on demand (VOD) content and the like may not be provided.

Korean Laid-open Patent Publication No. 10-2012-0123018 (hereinafter referred to as “related art 2”) discloses a system and method for generating an electronic program guide (EPG) for user generated content, in which the system and method include receiving a request for uploading content from a content producer as a content creator of User-Created Content (UCC), transmitting a request for content-related information to the content producer, receiving the content and content-related information from the content producer, and generating a personalized EPG based on the content and content-related information.

However, related art 2 has a drawback in that the personalized EPG is limited to the UCC, such that a program guide for real-time content and the like may not be provided.

Korean Laid-open Patent Publication No. 10-2011-0031646 (hereinafter referred to as “related art 3”) discloses a personal broadcasting service system and method using an EPG, in which the system and method include receiving and storing a custom EPG in which multimedia content items during a predetermined viewing period are scheduled in time slots, and playing in real time a multimedia content item, scheduled to be played at a current time among the multimedia content items stored in the custom EPG, by using the stored metadata.

However, related art 3 has a drawback in that the custom EPG is produced by a personal broadcasting platform management server and the like, such that the EPG may not include a combination of the real-time content and non-real-time content, but is limited to specific content.

### SUMMARY

It is an object of the present disclosure to provide an image display apparatus capable of providing a custom program guide including real-time content and non-real-time content, and a server.

Meanwhile, it is another object of the present disclosure to provide an image display apparatus capable of automatically providing a custom program guide including real-time content and non-real-time content, and a server.

Meanwhile, it is yet another object of the present disclosure to provide an image display apparatus capable of providing a custom program guide including real-time content and non-real-time content based on training, and a server.

Meanwhile, it is further another object of the present disclosure to provide an image display apparatus capable of sharing a custom program guide including real-time content and non-real-time content, and a server.

Meanwhile, it is yet another object of the present disclosure to provide an image display apparatus capable of providing a custom program guide including real-time content and non-real-time content for each user or a plurality of users.

In accordance with an aspect of the present disclosure, the above and other objects can be accomplished by providing an image display apparatus including: a display; a content receiving device configured to receive real-time content or non-real-time content from an external server or a content provider; and a signal processing device configured to generate a program guide by combining the real-time content and the non-real-time content which are received by the content receiving device, and to display the generated program guide on the display or display the content based on the generated program guide.

Meanwhile, after generating the program guide, the signal processing device may be configured to combine the real-time content and the non-real-time content and to display the content sequentially based on the generated program guide.

Meanwhile, the image display apparatus may further include a memory configured to store the generated program guide, wherein after power is turned on, the signal processing device may be configured to combine the real-time content and the non-real-time content and to display the content sequentially based on the generated program guide.

Meanwhile, the signal processing device may be configured to generate the program guide by combining the real-time content and the non-real-time content based on a viewing history of the real-time content and a viewing history of the non-real-time content, and to display the generated program guide on the display.

Meanwhile, the signal processing device is configured to perform learning based on the viewing history of the real-time content, the viewing history of the non-real-time content, and preference of the real-time content or the non-real-time content, to generate the program guide by combining the real-time content and the non-real-time content based on the learning, and to display the generated program guide on the display.

Meanwhile, the program guide may include a thumbnail image of each content and information of each content, wherein the program guide may be classified by content or content source.

The information of the each content may include content provider information, content title information, and content playback time information.

Meanwhile, the signal processing device may be configured to generate the program guide based on time information after power is turned on or after playback of first content is terminated, start information of the real-time content, and playback period information of the non-real-time content, and to display the generated program guide on the display.

Meanwhile, the signal processing device may be configured to generate the program guide by assigning priority to scheduling information of the real-time content, of scheduling information of the real-time content and scheduling information of the non-real-time content, and to display the generated program guide on the display.

Meanwhile, in response to a latest episode of the non-real-time content being uploaded, the signal processing device may be configured to generate the program guide by assigning priority to the scheduling information of the non-real-time content, of the scheduling information of the real-time content and the scheduling information of the non-real-time content, and to display the generated program guide on the display.

Meanwhile, the signal processing device may be configured to: allocate non-real-time content information for a first user in the program guide during a first period; and allocate real-time content information for a plurality of users in the program guide during a second period following the first period.

Meanwhile, the image display apparatus may further include a camera configured to capture an image, wherein the signal processing device may be configured to: based on the image captured by the camera or first log-in information, generate a first program guide for the first user; based on the image captured by the camera or second log-in information, generate a second program guide for the second user; and based on the image captured by the camera, generate a third program guide for a plurality of users.

Meanwhile, the signal processing device may be configured to transmit the generated program guide to a mobile terminal, another image display apparatus, or the server.

Meanwhile, the image display apparatus may further include a camera, wherein after transmitting the generated program guide to an external device, the signal processing device may be configured to control a video chatting screen, including the image captured by the camera and an image captured by another mobile terminal or another image display apparatus, to be displayed along with a content screen.

Meanwhile, the signal processing device may be configured to receive the second program guide from a mobile terminal or the server, to generate a program guide by combining the second program guide and the received real-time content information and non-real-time content information, and to display the generated program guide on the display.

Meanwhile, the signal processing device may be configured to receive the second program guide from a mobile terminal or the server, and in response to there being no access right to the first content in the second program guide, the signal processing device may be configured to replace the first content with second content, to generate a program guide based on the replaced second content, and to display the generated program guide on the display.

Meanwhile, in response to content capable of being delayed in playback being included in the real-time content or the non-real-time content in the program guide, the signal processing device may be configured to change a playback time of the content capable of being delayed in playback.

Meanwhile, in response to requiring content authentication, the signal processing device may be configured to exclude the content from the program guide and include another content to the program guide.

In accordance with another aspect of the present disclosure, there is provided an image display apparatus including: a display; a content receiving device configured to receive a program guide, including a combination of real-time content and non-real-time content, from an external mobile terminal or a server, or to receive real-time content or non-real-time content from the server or a content provider; and a signal processing device configured to display the real-time content or the non-real-time content based on the program guide received by the content receiving device.

In accordance with yet another aspect of the present disclosure, there is provided a server including: a transceiver configured to exchange data with an image display apparatus or a mobile terminal; a memory configured to store viewing history information from the image display apparatus or the mobile terminal; and a processor which, based on the viewing history information from the image display apparatus or the mobile terminal, is configured to generate a program guide including a combination of real-time content information and non-real-time content information, wherein the transceiver is configured to transmit the generated program guide to the image display apparatus or the mobile terminal.

### Effects

An image display apparatus according to an embodiment of the present disclosure includes: a display; a content receiving device configured to receive real-time content or non-real-time content from an external server or a content provider; and a signal processing device configured to generate a program guide by combining the real-time content and the non-real-time content which are received by the content receiving device, and to display the generated program guide on the display or display the content based on the generated program guide. Accordingly, a custom program guide including the real-time content and the non-real-time content may be provided.

Meanwhile, after generating the program guide, the signal processing device may be configured to combine the real-time content and the non-real-time content and to display the content sequentially based on the generated program guide. Accordingly, content based on a custom program guide, including the real-time content and the non-real-time content, may be provided.

Meanwhile, the image display apparatus may further include a memory configured to store the generated program guide, wherein after power is turned on, the signal processing device may be configured to combine the real-time content and the non-real-time content and to display the content sequentially based on the generated program guide. Accordingly, content based on a custom program guide, including the real-time content and the non-real-time content, may be provided.

Meanwhile, the signal processing device may be configured to generate the program guide by combining the real-time content and the non-real-time content based on a viewing history of the real-time content and a viewing history of the non-real-time content, and to display the generated program guide on the display. Accordingly, a custom program guide including the real-time content and the non-real-time content based on the viewing history may be provided.

Meanwhile, the signal processing device is configured to perform learning based on the viewing history of the real-time content, the viewing history of the non-real-time content, and preference of the real-time content or the non-real-time content, to generate the program guide by combining the real-time content and the non-real-time content based on the learning, and to display the generated program guide on the display. Accordingly, a custom program guide including the real-time content and the non-real-time content based on the learning may be provided.

Meanwhile, the program guide may include a thumbnail image of each content and information of each content, wherein the program guide may be classified by content or content source. Accordingly, a custom program guide including the real-time content and the non-real-time content may be provided.

The information of the each content may include content provider information, content title information, and content playback time information. Accordingly, a custom program guide including the real-time content and the non-real-time content may be provided.

Meanwhile, the signal processing device may be configured to generate the program guide based on time information after power is turned on or after playback of first content is terminated, start information of the real-time content, and playback period information of the non-real-time content, and to display the generated program guide on the display. Accordingly, a custom program guide including the real-time content and the non-real-time content may be provided.

Meanwhile, the signal processing device may be configured to generate the program guide by assigning priority to scheduling information of the real-time content, of scheduling information of the real-time content and scheduling information of the non-real-time content, and to display the generated program guide on the display. Accordingly, a custom program guide may be provided in which priority is assigned to the real-time content, of the real-time content and the non-real-time content.

Meanwhile, in response to a latest episode of the non-real-time content being uploaded, the signal processing device may be configured to generate the program guide by assigning priority to the scheduling information of the non-real-time content, of the scheduling information of the real-time content and the scheduling information of the non-real-time content, and to display the generated program guide on the display. Accordingly, a custom program guide may be provided in which priority is assigned to the non-real-time content, of the real-time content and the non-real-time content.

Meanwhile, the signal processing device may be configured to: allocate non-real-time content information for a first user in the program guide during a first period; and allocate real-time content information for a plurality of users in the program guide during a second period following the first period. Accordingly, a custom program guide including the real-time content and the non-real-time content may be provided.

Meanwhile, the image display apparatus may further include a camera configured to capture an image, wherein the signal processing device may be configured to: based on the image captured by the camera or first log-in information, generate a first program guide for the first user; based on the image captured by the camera or second log-in information, generate a second program guide for the second user; and based on the image captured by the camera, generate a third program guide for a plurality of users. Accordingly, a custom program guide including the real-time content and the non-real-time content may be provided for each user.

Meanwhile, the signal processing device may be configured to transmit the generated program guide to a mobile terminal, another image display apparatus, or the server. Accordingly, a custom program guide including the real-time content and the non-real-time content may be shared with another device.

Meanwhile, the image display apparatus may further include a camera, wherein after transmitting the generated program guide to an external device, the signal processing device may be configured to control a video chatting screen, including the image captured by the camera and an image captured by another mobile terminal or another image display apparatus, to be displayed along with a content screen. Accordingly, video chatting based on a custom program guide including the real-time content and the non-real-time content may be provided.

Meanwhile, the signal processing device may be configured to receive the second program guide from a mobile terminal or the server, to generate a program guide by combining the second program guide and the received real-time content information and non-real-time content information, and to display the generated program guide on the display. Accordingly, a custom program guide including the real-time content and the non-real-time content may be provided based on the second program guide received from an external device.

Meanwhile, the signal processing device may be configured to receive the second program guide from a mobile terminal or the server, and in response to there being no access right to the first content in the second program guide, the signal processing device may be configured to replace the first content with second content, to generate a program guide based on the replaced second content, and to display the generated program guide on the display. Accordingly, a custom program guide including the real-time content and the non-real-time content may be provided in consideration of the access right to content.

Meanwhile, in response to content capable of being delayed in playback being included in the real-time content or the non-real-time content in the program guide, the signal processing device may be configured to change a playback time of the content capable of being delayed in playback. Accordingly, a playback time may change during playback of content based on a custom program guide including the real-time content and the non-real-time content.

Meanwhile, in response to requiring content authentication, the signal processing device may be configured to exclude the content from the program guide and include another content to the program guide. Accordingly, a custom program guide including the real-time content and the non-real-time content may be provided in consideration of the authentication.

In accordance with another aspect of the present disclosure, there is provided an image display apparatus including: a display; a content receiving device configured to receive a program guide, including a combination of real-time content and non-real-time content, from an external mobile terminal or a server, or to receive real-time content or non-real-time content from the server or a content provider; and a signal processing device configured to display the real-time content or the non-real-time content based on the program guide received by the content receiving device. Accordingly, a custom program guide including the real-time content and the non-real-time content may be received from an external device, and content based on the received custom program guide may be provided.

In accordance with yet another aspect of the present disclosure, there is provided a server including: a transceiver configured to exchange data with an image display apparatus or a mobile terminal; a memory configured to store viewing history information from the image display apparatus or the mobile terminal; and a processor which, based on the viewing history information from the image display apparatus or the mobile terminal, is configured to generate a program guide including a combination of real-time content information and non-real-time content information, wherein the transceiver is configured to transmit the generated program guide to the image display apparatus or the mobile terminal. Accordingly, a custom program guide including the real-time content and the non-real-time content may be provided to the image display apparatus or the mobile terminal.

### BRIEF DESCRIPTION OF THE DRAWINGS

FIG. 1 is a diagram illustrating an image display system of one embodiment of the present disclosure.

FIG. 2 is an internal block diagram illustrating an image display apparatus of FIG. 1.

FIG. 3 is an internal block diagram illustrating a signal processing device of FIG. 2.

FIG. 4A illustrates a method for controlling a remote controller of FIG. 2.

FIG. 4B is an internal block diagram illustrating the remote controller of FIG. 2.

FIG. 5 is an internal block diagram illustrating a mobile terminal of FIG. 1.

FIG. 6 is an internal block diagram of a server of FIG. 1.

FIG. 7 is a flowchart illustrating a method of operating an image display apparatus according to an embodiment of the present disclosure.

FIGS. 8A to 19B are diagrams referred to in the description of operation of FIG. 7.

### DETAILED DESCRIPTION OF THE PREFERRED EMBODIMENTS

Hereinafter, the present disclosure will be described in detail with reference to the accompanying drawings.

As used herein, the suffixes “module” and “unit” are added to simply facilitate preparation of this specification and are not intended to suggest special meanings or functions. Therefore, the suffixes “module” and “unit” may be used interchangeably.

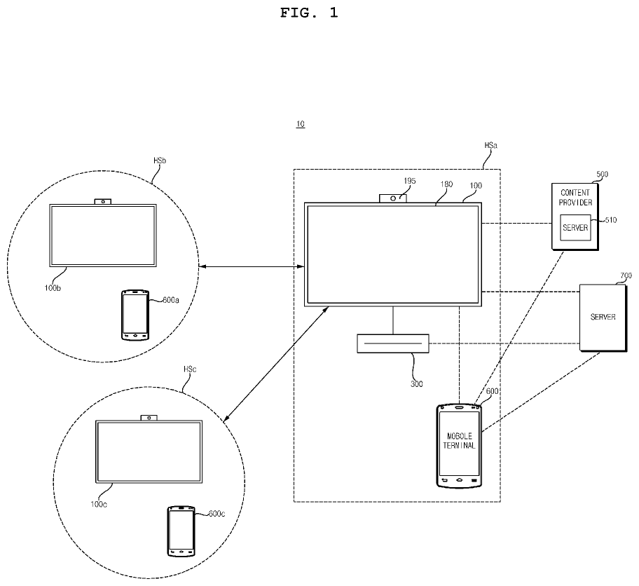

FIG. 1 is a diagram illustrating an image display system according to an embodiment of the present disclosure.

Referring to the drawing, an image display system 10 according to an embodiment of the present disclosure may include an image display apparatus 100 including a display 180, a content provider 500 configured to provide real-time content, and a server 700 configured to provide non-real-time content or to store viewing history information received from the image display device 100 and the like.

The image display apparatus 100 according to an embodiment of the present disclosure may receive real-time content or non-real-time content from an external server 700 or the content provider 500, may generate a program guide by combining the received real-time content and non-real-time content, and may display the generated program guide on the display 180 or display the content based on the generated program guide. Accordingly, a custom program guide including the real-time content and the non-real-time content may be provided.

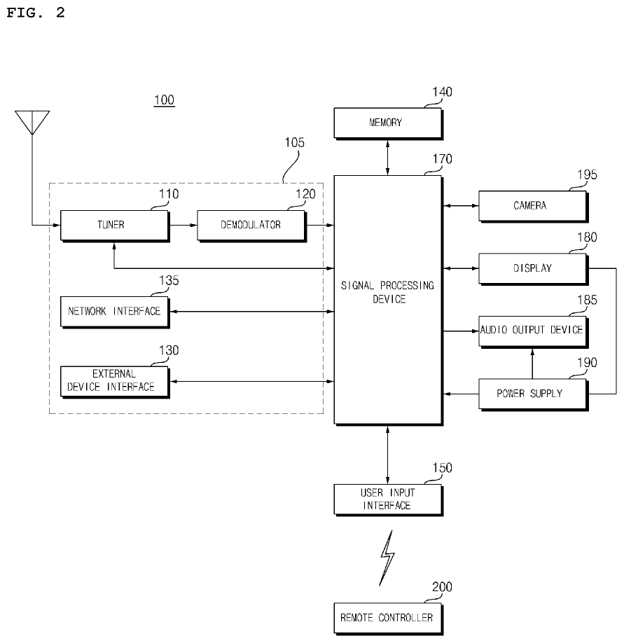

Specifically, the image display device 100 according to an embodiment of the present disclosure includes: the display 180; a content receiving device 105 (see FIG. 2) configured to receive real-time content or non-real-time content from the external server 700 or the content provider 500; and a signal processing device 170 (see FIG. 2) configured to generate a program guide by combining the real-time content and the non-real-time content which are received by the content receiving device 105, and to display the generated program guide on the display 180 or display the content based on the generated program guide. Accordingly, a custom program guide including the real-time content and the non-real-time content may be provided.

Meanwhile, the image display apparatus 100 according to an embodiment of the present disclosure may receive real-time content from the content provider 500 or a set-top box 300.

In this case, the real-time content may include live or real-time broadcast video transmitted by broadcasting stations based on broadcast standards, live streaming video, and the like.

Meanwhile, the non-real-time content may include video on demand (VOD) from the external server 700 or streaming video on demand, or the like.

Meanwhile, the custom program guide including the real-time content and the non-real-time content may also be generated by a mobile terminal 600, instead of the image display apparatus 100.

That is, the mobile terminal 600 may receive real-time content or non-real-time content from the external server 700 or the content provider 500, may generate a program guide by combining the received real-time content and non-real-time content, and may display the generated program guide on the display 180 or display the content based on the generated program guide. Accordingly, a custom program guide including the real-time content and the non-real-time content may be provided.

Meanwhile, the custom program guide including the real-time content and the non-real-time content may also be generated by the server 700, instead of the image display apparatus 100.

That is, the server 700 according to an embodiment of the present disclosure may generate a program guide, including a combination of the real-time content and the non-real-time content, based on viewing history information from the image display apparatus 100 or the mobile terminal 600. Further, the server 700 may transmit the generated program guide to the image display apparatus 100 or the mobile terminal 600 to share the program guide. Accordingly, a custom program guide including the real-time content and the non-real-time content may be provided.

Meanwhile, the custom program guide including the real-time content and the non-real-time content may be transmitted to the mobile terminal 600 to be shared.

Accordingly, the same real-time content or the same non-real-time content may be played and displayed by the image display apparatus 100 and the mobile terminal 600.

Meanwhile, the image display apparatus 100 according to another embodiment of the present disclosure includes: a display 180; a content receiving device 105 (see FIG. 2) configured to receive a program guide, including a combination of real-time content and non-real-time content, from an external mobile terminal 600 or a server 700, or to receive real-time content or non-real-time content from the server 700 or a content provider 500; and a signal processing device 170 (see FIG. 2) configured to control the real-time content or the non-real-time content to be to displayed based on the program guide received by the content receiving device 105. Accordingly, a custom program guide including the real-time content and the non-real-time content may be provided from an external device, and content based on the received custom program guide may be provided.

In the drawing, an example is illustrated in which the image display apparatus 100 and the mobile terminal 600 are located in the same place HSa and the same network address is used, but the present disclosure is not limited thereto, and another network address may also be used.

Meanwhile, the custom program guide, generated by the image display apparatus 100 or the mobile terminal 600 and including the real-time content and the non-real-time content, may be transmitted to a second image display apparatus 100b or a second mobile terminal 600b in another place HSb or to a third image display apparatus 100c or a third mobile terminal 600c in yet another place HSb, etc., to be shared. Accordingly, a custom program guide including the real-time content and the non-real-time content may be shared with another apparatus or the server 700.

Meanwhile, the second image display apparatus 100b or the second mobile terminal 600b in another place HSb may generate a second program guide including the real-time content and the non-real-time content, and may share the generated second program guide with another apparatus or the server 700.

Meanwhile, the third image display apparatus 100c or the third mobile terminal 600c in yet another place HSb may generate a third program guide including the real-time content and the non-real-time content, and may share the generated third program guide with another apparatus or the server 700.

Meanwhile, the image display apparatus 100 may generate a custom program guide including the real-time content and the non-real-time content, by using a Deep Neural Network and the like.

Meanwhile, the display 180 in the image display apparatus 100 may be implemented as any one of various panels. For example, the display 180 may be any one of a liquid crystal display (LCD) panel, organic light-emitting diode (OLED) panel, inorganic light-emitting diode (LED) panel, and the like.

Meanwhile, the image display apparatus 100 of FIG. 1 may be a TV, a monitor, a tablet PC, or a vehicle display device, and the like.

Meanwhile, the mobile terminal 600 of FIG. 1 may be a tablet PC, a smartphone, and the like.

FIG. 2 is an internal block diagram illustrating the image display apparatus of FIG. 1.

Referring to the drawing, the image display apparatus 100 according to an embodiment of the present disclosure may include a content receiving device 105, a memory 140, a user input interface 150, a sensor device (not illustrated), a signal processing device 170, a display 180, an audio output device 185, a power supply 190, and a camera 195.

Meanwhile, the signal processing device 170 in the drawing may correspond to the aforementioned signal processing device.

The content receiving device 105 may include a tuner 110, a demodulator 120, a network interface 130, and an external device interface 130.

Unlike the drawing, the content receiving device 105 may include only the tuner 110, the demodulator 120, and the external device interface 130. That is, the content receiving device 105 may not include the network interface 130.

The tuner 110 selects a channel selected by a user from among radio frequency (RF) broadcast signals received through an antenna (not illustrated) or an RF broadcast signal corresponding to all pre-stored channels. In addition, the tuner 110 converts the selected RF broadcast signal into a middle-frequency signal, a baseband image, or a voice signal.

For example, if the selected RF broadcast signal is a digital broadcast signal, the tuner 110 may convert the selected broadcast signal into a digital IF signal (DIF), and if the selected broadcast signal is an analog broadcast signal, the tuner 100 may convert the selected broadcast signal into an analog baseband video or audio signal CVBS/SIF. That is, the tuner 110 may process digital broadcast signals or analog broadcast signals. The analog baseband video or audio signal CVBS/SIF output from the tuner 110 may be directly input to the controller 170.

To receive broadcast signals of a plurality of channels, a plurality of tuners 110 may be provided. Alternatively, a single tuner to receive a plurality of channels simultaneously may be provided.

The demodulator 120 receives and demodulates a digital IF (DIF) signal converted by the tuner 110.

After performing demodulation and channel decoding, the demodulator 120 may output a stream signal (TS). Herein, the stream signal may be a signal obtained by multiplexing an image signal, voice signal or data signal.

The stream signal output from the demodulator 120 may be input to the signal processing device 170. After performing demultiplexing and image/voice signal processing, the signal processing device 170 outputs an image to the display 180 and voice to the audio output device 185.

The external device interface 130 may transmit or receive data to or from a connected external device (not illustrated), for example, a set-top box 50. To this end, the external device interface 130 may include an A/V input/output device (not illustrated).

The external device interface 130 may be connected to external devices such as a digital versatile disc (DVD) player, a Blu-ray player, a gaming device, a camera, a camcorder, a computer (laptop), and a set-top box in a wired/wireless manner, and perform input/output operations with external devices.

The A/V input/output device may receive the image and voice signal of the external device. Meanwhile, the wireless transceiver (not illustrated) 130 may perform short-range wireless communication with other electronic devices.

The external device interface 130 may exchange data with a neighboring mobile terminal 600 via the wireless transceiver (not illustrated). In particular, in the mirroring mode, the external device interface 130 may receive device information, information about an executed application and an application image from the mobile terminal 600.

The network interface 135 provides an interface for connecting the image display apparatus to a wired/wireless network including the Internet. For example, the network interface 135 may receive content or data provided by the Internet or a content provider or network operator through a network.

The network interface 135 may include a wireless transceiver (not illustrated).

The memory 140 may store programs for processing and control of signals in the signal processing device 170, and also store a signal-processed image, voice signal or data signal.

The memory 140 may function to temporarily store an image signal, a voice signal, or a data signal input through the external device interface 130. In addition, the storage device 140 may store information about a predetermined broadcast channel through the channel memorization function such as a channel map.

While it is illustrated in FIG. 2 that the memory 140 is provided separately from the signal processing device 170, embodiments of the present disclosure are not limited thereto. The storage device 140 may be included in the signal processing device 170.

The user input interface 150 may transmit a signal input by the user to the signal processing device 170 or transmit a signal from the signal processing device 170 to the user.

For example, the user input interface 150 may transmit/receive user input signals such as power on/off, channel selection, and screen setting to/from the remote controller 200, deliver user input signals input through local keys (not illustrated) such as a power key, a channel key, a volume key, or a setting key, deliver user input signals input through a sensor device (not illustrated) to sense user gestures to the signal processing device 170, or transmit a signal from the signal processing device 170 to the sensor device (not illustrated).

The signal processing device 170 may demultiplex streams input through the tuner 110, demodulator 120, network interface 135, or external device interface 130, or process demultiplexed signals. Thereby, the signal processing device 170 may generate an output signal for outputting an image or voice.

For example, the signal processing device 170 may receive a broadcast signal or HDMI signal received from the content receiving device 105, perform signal processing based on the received broadcast signal or HDMI signal, and output the signal-processed image signal.

An image signal image-processed by the signal processing device 170 may be input to the display 180 and an image corresponding to the image signal may be displayed. In addition, the image signal which is image-processed by the signal processing device 170 may be input to an external output device through the external device interface 130.

A voice signal processed by the signal processing device 170 may be output to the audio output device 185 in the form of sound. In addition, the voice signal processed by the signal processing device 170 may be input to an external output device through the external device interface 130.

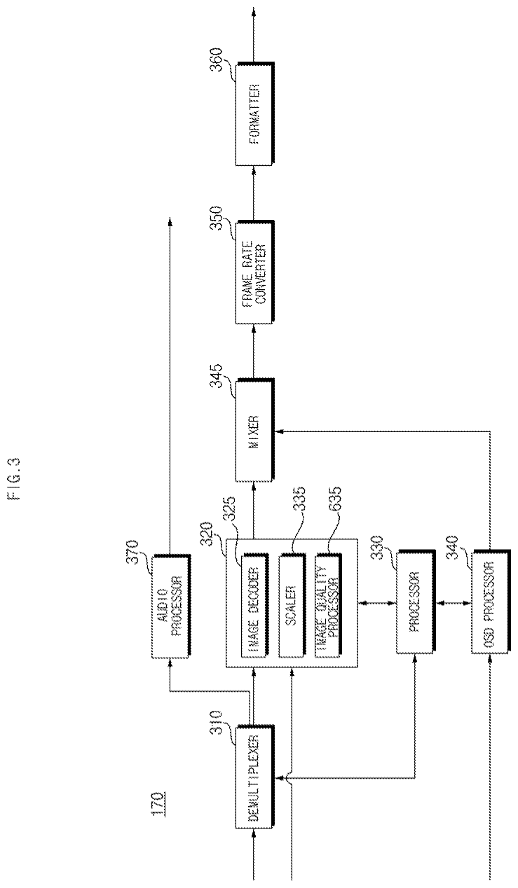

Although not illustrated in FIG. 2, the signal processing device 170 may include a demultiplexer, an image processor, and the like. That is, the signal processing device 170 may perform various signal processing, and thus may be implemented in the form of a System On Chip (SOC). This will be described later with reference to FIG. 3.

Additionally, the signal processing device 170 may control overall operation of the image display apparatus 100. For example, the signal processing device 170 may control the tuner 110 to tune to an RF broadcast corresponding to a channel selected by the user or a pre-stored channel.

The signal processing device 170 may control the image display apparatus 100 according to a user command input through the user input interface 150 or an internal program.

The signal processing device 170 may control the display 180 to display an image. Herein, the image displayed on the display 180 may be a still image, a moving image, a 2D image, or a 3D image.

The signal processing device 170 may be configured to display the predetermined object in an image displayed on the display 180. For example, the object may be at least one of an accessed web page (a newspaper, a magazine, or the like), electronic program guide (EPG), various menus, a widget, an icon, a still image, a moving image, and text.

The signal processing device 170 may recognize a user's position based on the images captured by the camera 195. For example, signal processing device 170 may identify a distance (z-axis coordinates) between the user and the image display apparatus 100. In addition, the signal processing device 170 may identify x-axis coordinates and y-axis coordinates corresponding to a user's position in the display 180.

The display 180 generates drive signals by converting an image signal, data signal, OSD signal, and control signal processed by the signal processing device 170 or an image signal, data signal, and control signal received from the external device interface 130.

The display 180 may be configured as a touch screen and used as an input device in addition to an output device.

The audio output device 185 receives an audio signal processed by the signal processing device 170 and outputs audio.

The power supply 190 supplies corresponding power throughout the image display apparatus 100. In particular, the power supply 190 may supply power to the signal processing device 170 which can be implemented in the form of a System On Chip (SOC), the display 180 for displaying images, an audio output device 185 for outputting audio, or the like.

Specifically, the power supply 190 may include a converter to convert alternating current (AC) power into direct current (DC) power and a DC-DC converter to change the level of the DC power.

Meanwhile, the camera 195 may capture images of a user. The camera 195 may be implemented with one camera, but is not limited thereto, and may also be implemented with a plurality of cameras. The images captured by the camera 195 may be input to the signal processing device 170.

The signal processing device 170 may sense a user's gesture based on the images captured by the camera 195 or the respective signals sensed by the sensor device (not shown), or a combination thereof.

The remote controller 200 transmits user input to the user input interface 150. To this end, the remote controller 200 may employ Bluetooth, radio frequency (RF) communication, infrared (IR) communication, ultra-wideband (UWB), or ZigBee. In addition, the remote controller 200 may receive an image signal, a voice signal, or a data signal output from the user input interface 150, and display the signals on the remote controller 200 or voice-output.

The image display apparatus 100 may be a fixed or mobile digital broadcast receiver capable of receiving digital broadcast services.

The block diagram of the image display apparatus 100 illustrated in FIG. 2 is a block diagram for one embodiment of the present disclosure. Constituents of the block diagram may be integrated, added or omitted according to the specifications of the image display apparatus 100 which is implemented in reality. That is, two or more constituents may be combined into one constituent, or one constituent may be subdivided into two or more constituents, when necessary. In addition, the function performed in each block is simply illustrative, and it should be noted that specific operations or devices of the blocks do not limit the scope of the present disclosure.

FIG. 3 is an internal block diagram illustrating the signal processing device of FIG. 2.

Referring to the drawings, the signal processing device 170 according to one embodiment of the present disclosure may include a demultiplexer 310, an image processor 320, a processor 330, and an audio processor 370. In addition, the signal processing device 170 may further include a data processor (not illustrated).

The demultiplexer 310 demultiplexes an input stream. For example, when an MPEG-2 TS is input, the demultiplexer 310 may demultiplex the MPEG-2 TS to separate the MPEG-2 TS into an image signal, a voice signal and a data signal. Herein, the stream signal input to the demultiplexer 310 may be a stream signal output from the tuner 110, the demodulator 120 or the external device interface 130.

The image processor 320 may perform signal processing on an input image. For example, the image processor 320 may perform image processing of an image signal demultiplexed by the demultiplexer 310.

To this end, the image processor 320 includes an image decoder 325, a scaler 335, an image-quality processor 635, an image encoder (not illustrated), an OSD generator 340, a frame rate converter 350, and a formatter 360, and the like.

The image decoder 325 decodes the demultiplexed image signal, and the scaler 335 scales the resolution of the decoded image signal such that the image signal can be output through the display 180.

The image decoder 325 may include decoders of various standards. For example, the image decoder 325 may include an MPEG-2 decoder, an H.264 decoder, a 3D image decoder for color images and depth images, and a decoder for multi-viewpoint images.

The scaler 335 may scale an input image signal that has been image decoded by the image decoder 325 or the like.

For example, the scaler 335 may perform up-scaling when the size or resolution of the input image signal is small, and down-scaling when the size or resolution of the input image signal is large.

The image-quality processor 635 may perform image quality processing on an input image signal that has been image decoded in the image decoder 325 or the like.

For example, the image-quality processor 635 may perform noise removal processing of the input image signal, expand the resolution of gray levels of an input image signal, improve image resolution, performs high dynamic range (HDR) based signal processing, change the frame image rate, or perform image quality processing corresponding to panel characteristics, particularly organic light emitting panels or the like.

The OSD generator 340 generates an OSD signal automatically or according to user input. For example, the OSD generator 340 may generate a signal for display of various kinds of information in the form of images or text on the screen of the display 180 based on a user input signal. The generated OSD signal may include various data including the user interface screen window of the image display apparatus 100, various menu screen windows, widgets, and icons. The generated OSD signal may also include a 2D object or a 3D object.

The OSD generator 340 may generate a pointer which can be displayed on the display, based on a pointing signal input from the remote controller 200. In particular, the pointer may be generated by a pointing signal processing device (not illustrated), and the OSD generator 340 may include the pointing signal generator. Of course, it is possible to provide the pointing signal processing device (not illustrated) separately from the OSD generator 340.

The frame rate converter (FRC) 350 may convert the frame image rate of an input image. The FRC 350 may output frames without performing separate frame image rate conversion.

The formatter 360 may change the format of an input image signal into an image signal for display on a display and output the changed image signal.

In particular, the formatter 360 may change the format of the image signal to correspond to the display panel.

The processor 330 may control overall operations within the image display apparatus 100 or signal processing device 170.

For example, the processor 330 may control the tuner 110 to select (tuning) an RF broadcast corresponding to a channel selected by a user or a pre-stored channel.

The processor 330 may control the image display apparatus 100 according to a user command input through the user input interface 150 or an internal program.

The processor 330 may perform data transfer control with the network interface 135 or the external device interface 130.

The processor 330 may control operations of the demultiplexer 310 and the image processor 320 within the signal processing device 170.

An audio processor 370 in the signal processing device 170 may voice-process a demultiplexed voice signal. To this end, the audio processor 370 may include various decoders.

The audio processor 370 in the signal processing device 170 may perform processing such as adjustment of bass, treble, and volume.

The data processor (not illustrated) in the signal processing device 170 may perform data processing on a demultiplexed data signal. For example, when the demultiplexed data signal is a coded data signal, the data processor (not illustrated) may decode the data signal. The coded data signal may be electronic program guide information including broadcast information such as a start time and end time of a broadcast program broadcast on each channel.

The block diagram of the signal processing device 170 illustrated in FIG. 3 is a block diagram for one embodiment of the present disclosure. Constituents of the block diagram may be integrated, added, or omitted according to the specifications of the signal processing device 170 which is implemented in reality.

In particular, the frame rate converter 350 and the formatter 360 may be separately provided in addition to the image processor 320.

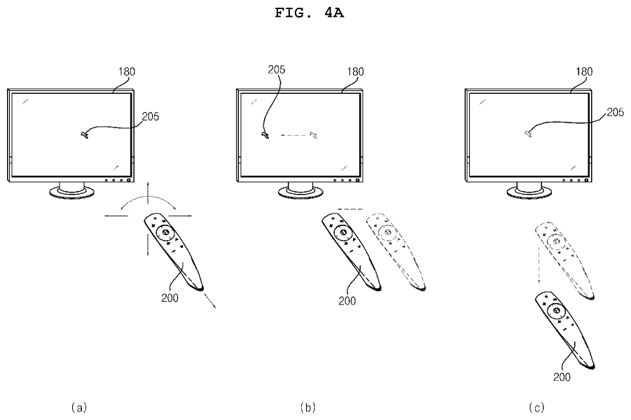

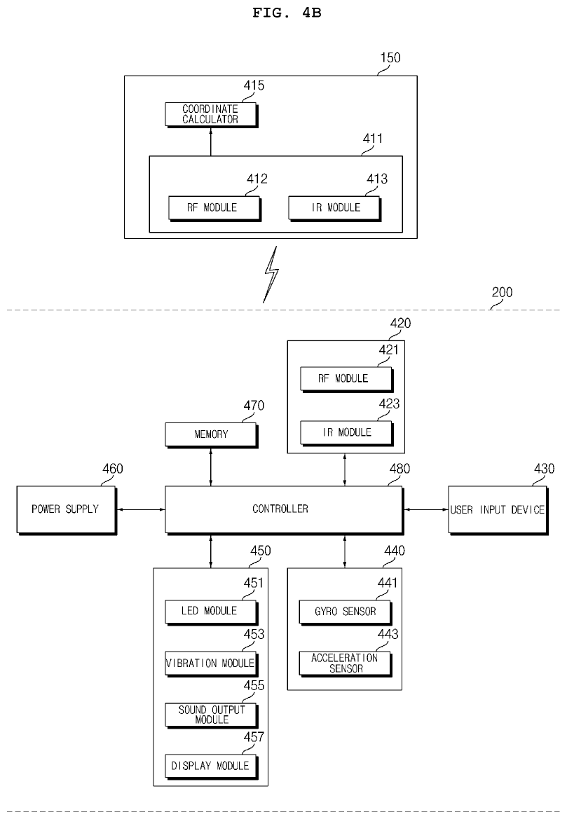

FIG. 4A illustrates a method for controlling the remote controller of FIG. 2.

As illustrated in FIG. 4A(a), a pointer 205 corresponding to the remote controller 200 may be displayed on the display 180.

The user may move the remote controller 200 up and down, left and right (FIG. 4A(b)), or back and forth (FIG. 4A(c)) or rotate the same. The pointer 205 displayed on the display 180 of the image display apparatus corresponds to movement of the remote controller 200. As illustrated in the drawings, since the pointer 205 moves according to movement of the remote controller 200 in the 3D space, the remote controller 200 may be referred to as a spatial remote control or a 3D pointing device.

FIG. 4A(b) illustrates a case where the pointer 205 displayed on the display 180 of the image display apparatus moves to the left when the user moves the remote controller 200 to the left.

Information about movement of the remote controller 200 sensed through a sensor of the remote controller 200 is transmitted to the image display apparatus. The image display apparatus may calculate coordinates of the pointer 205 based on the information about the movement of the remote controller 200. The image display apparatus may display the pointer 205 such that the pointer 205 corresponds to the calculated coordinates.

FIG. 4A(c) illustrates a case where the user moves the signal processing device 170 away from display 180 in a state where the user presses down a specific button in the remote controller 200. In this case, a selected area on the display 180 corresponding to the pointer 205 may be zoomed in and displayed with the size thereof increased. On the other hand, when the user moves the remote controller 200 closer to the display 180, the selected area in the display 180 corresponding to the pointer 205 may be zoomed out and displayed with the size thereof reduced. Alternatively, the selected area may be zoomed out when the remote controller 200 moves away from the display 180, and may be zoomed in when the remote controller 200 moves closer to the display 180.

Vertical and lateral movement of the remote controller 200 may not be recognized while the specific button in the remote controller 200 is pressed down. That is, when the remote controller 200 approaches or moves away from the display 180, vertical and lateral movements thereof may not be recognized, but back-and-forth movement thereof may be recognized. When the specific button in the remote controller 200 is not pressed down, the pointer 205 only moves according to vertical and lateral movements of the remote controller 200.

The speed and direction of movement of the pointer 205 may correspond to the speed and direction of movement of the remote controller 200.

FIG. 4B is an internal block diagram illustrating the remote controller of FIG. 2.

Referring to the drawing, the remote controller 200 may include a wireless transceiver 425, a user input device 430, a sensor device 440, an output device 450, a power supply 460, a memory 470, and a controller 480.

The wireless transceiver 425 transmits and receives signals to and from one of the image display apparatuses according to embodiments of the present disclosure described above. Hereinafter, one image display apparatus 100 according to one embodiment of the present disclosure will be described.

In this embodiment, the remote controller 200 may include an RF module 421 capable of transmitting and receiving signals to and from the image display apparatus 100 according to an RF communication standard. The remote controller 200 may further include an IR module 423 capable of transmitting and receiving signals to and from the image display apparatus 100 according to an IR communication standard.

In this embodiment, the remote controller 200 transmits a signal including information about movement of the remote controller 200 to the image display apparatus 100 via the RF module 421.

In addition, the remote controller 200 may receive a signal from the image display apparatus 100 via the RF module 421. When necessary, the remote controller 200 may transmit commands related to power on/off, channel change, and volume change to the image display apparatus 100 via the IR module 423.

The user input device 430 may include a keypad, a button, a touchpad, or a touchscreen. The user may input a command related to the image display apparatus 100 with the remote controller 200 by manipulating the user input device 435. When the user input device 435 includes a hard key button, the user may input a command related to the image display apparatus 100 with the remote controller 200 by pressing the hard key button. When the user input device 435 includes a touchscreen, the user may input a command related to the image display apparatus 100 with the remote controller 200 by touching a soft key on the touchscreen. The user input device 430 may include various kinds of input means such as a scroll key and a jog key which are manipulatable by the user, but it should be noted that this embodiment does not limit the scope of the present disclosure.

The sensor device 440 may include a gyro sensor 441 or an acceleration sensor 443. The gyro sensor 441 may sense information about movement of the remote controller 200.

For example, the gyro sensor 441 may sense information about movement of the remote controller 200 with respect to the X, Y and Z axes. The acceleration sensor 443 may sense information about the movement speed of the remote controller 200. The sensor device 440 may further include a distance measurement sensor to sense a distance to the display 180.

The output device 450 may output an image signal or voice signal corresponding to manipulation of the user input device 435 or a signal transmitted from the image display apparatus 100. The user may recognize, via the output device 450, whether the user input device 435 is manipulated or the image display apparatus 100 is controlled.

For example, the output device 450 may include an LED module 451 to be turned on when the user input device 35 is operated or signals are transmitted to and received from the image display apparatus 100 via the wireless transceiver 425, a vibration module 453 to generate vibration, a sound output module 455 to output sound, or a display module 457 to output an image.

The power supply 460 supplies power to the remote controller 200. When the remote controller 200 does not move for a predetermined time, the power supply 460 may stop supplying power to save power. The power supply 460 may resume supply of power when the predetermined key provided to the remote controller 200 is manipulated.

The memory 470 may store various kinds of programs and application data necessary for control or operation of the remote controller 200. When the remote controller 200 wirelessly transmits and receives signals to and from the image display apparatus 100 via the RF module 421, the remote controller 200 and the image display apparatus 100 may transmit and receive signals in a predetermined frequency band. The controller 480 of the remote controller 200 may store, in the memory 470, information about, for example, a frequency band enabling wireless transmission and reception of signals to and from the image display apparatus 100 which is paired with the remote controller 200, and reference the same.

The controller 480 controls overall operation related to control of the remote controller 200. The controller 480 may transmit, via the wireless transceiver 425, a signal corresponding to manipulation of a predetermined key in the user input device 435 or a signal corresponding to movement of the remote controller 200 sensed by the sensor device 440 to the image display apparatus 100.

The user input interface 150 of the image display apparatus 100 may include a wireless transceiver 151 capable of wirelessly transmitting and receiving signals to and from the remote controller 200 and a coordinate calculator 415 capable of calculating coordinates of the pointer corresponding to operation of the remote controller 200.

The user input interface 150 may wirelessly transmit and receive signals to and from the remote controller 200 via an RF module 412. In addition, the user input interface 150 may receive, via an IR module 413, a signal transmitted from the remote controller 200 according to an IR communication standard.

The coordinate calculator 415 may calculate coordinates (x, y) of the pointer 205 to be displayed on the display 180, by correcting hand tremor or an error in a signal corresponding to operation of the remote controller 200 which is received via the wireless transceiver 151.

The transmitted signal of the remote controller 200 input to the image display apparatus 100 via the user input interface 150 is transmitted to the signal processing device 170 of the image display apparatus 100. The signal processing device 170 may determine information about an operation of the remote controller 200 or manipulation of a key from the signal transmitted from the remote controller 200, and control the image display apparatus 100 according to the information.

In another example, the remote controller 200 may calculate coordinates of the pointer corresponding to movement thereof and output the same to the user input interface 150 of the image display apparatus 100. In this case, the user input interface 150 of the image display apparatus 100 may transmit, to the signal processing device 170, information about the received coordinates of the pointer without separately correcting hand tremor or the error.

Further, in another example, in contrast with the example of the drawing, the coordinate calculator 415 may be provided in the signal processing device 170 rather than in the user input interface 150.

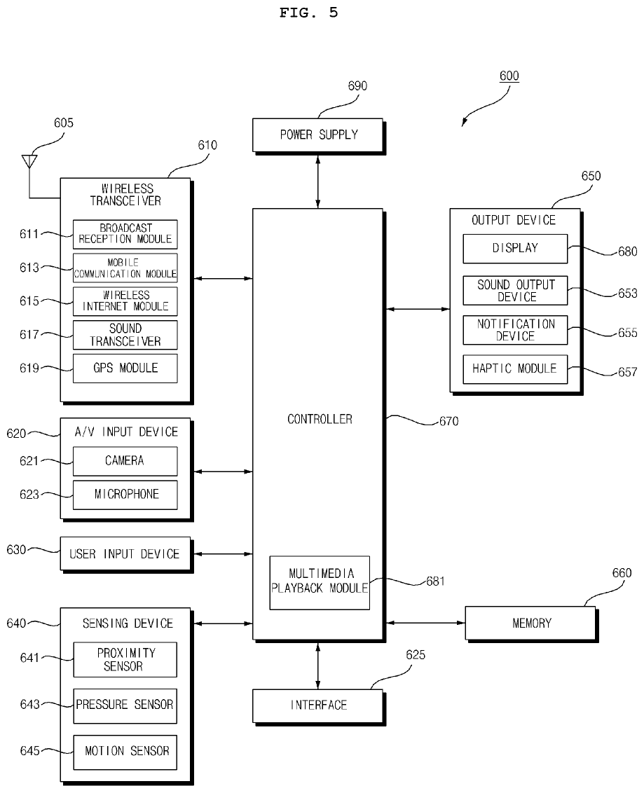

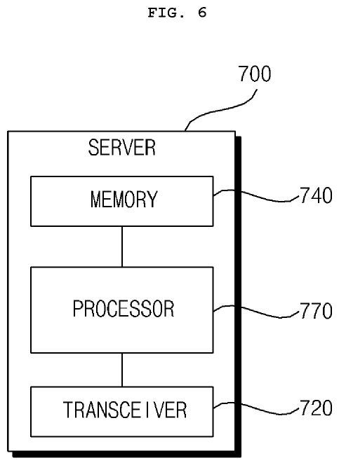

FIG. 5 is an internal block diagram illustrating the mobile terminal of FIG. 1.

Referring to the drawing, the mobile terminal 600 may include a wireless transceiver 610, an audio/video (A/V) input device 620, a user input device 630, a sensing device 640, and an output device 650, a memory 660, an interface 625, a controller 670 and a power supply 690.

The wireless transceiver 610 may include a broadcast reception module 611, a mobile communication module 613, a wireless internet module 615, a sound transceiver 617, and a GPS module 619.

The broadcast reception module 611 may receive at least one of a broadcast signal or broadcast-related information from an external broadcast management server over a broadcast channel. Herein, the broadcast channel may include a satellite channel and a terrestrial channel.

The broadcast signal and/or broadcast-related information received through the broadcaster reception module 611 may be stored in the memory 660.

The mobile communication module 613 transmits and receives a radio signal to and from at least one of a base station, an external terminal or a server over a mobile communication network. Herein, the radio signal may include a voice call signal, a video call signal, or various kinds of data according to transmission and reception of a text/multimedia message.

The wireless internet module 615, which refers to a module for wireless communication access, may be installed inside or outside the mobile terminal 600. For example, the wireless internet module 615 may perform Wi-Fi-based wireless communication or Wi-Fi Direct-based wireless communication.

The sound transceiver 617 may perform sound communication. In the sound communication mode, the sound transceiver 617 may add data of predetermined information to audio data which is to be output and output sound. In addition, in the sound communication mode, the sound transceiver 617 may extract data of predetermined information from received sound.

Applicable short-range communication technologies may include Bluetooth, radio frequency identification (RFID), Infrared Data Association (IrDA), Ultra-Wideband (UWB), and ZigBee.

The GPS module 619 may receive location information from a plurality of GPS satellites.

The A/V input device 620 is used for input of an audio signal or a video signal and may include a camera 621 and a microphone 623.

The user input device 630 generates key input data input by the user to control operation of a terminal of the user. To this end, the user input device 630 may include a keypad, a dome switch, and a touchpad (resistive touchpad/capacitive touchpad). In particular, the touchpad may form a layered architecture together with the display 680, thereby realizing a touchscreen.

The sensing device 640 may generate a sensing signal for controlling operation of the mobile terminal 600 by sensing the current state of the mobile terminal 600, for example by sensing whether the mobile terminal 600 is in the open or closed position, where the mobile terminal 600 is located, and whether the user contacts the mobile terminal 600.

The sensing device 640 may include a proximity sensor 641, a pressure sensor 643 and a motion sensor 645. The motion sensor 645 may employ an acceleration sensor, a gyro sensor, a gravity sensor and the like to sense movement or the location of the mobile terminal. In particular, the gyro sensor, which is used to measure an angular speed, may sense orientation (angle) of the mobile terminal with respect to a reference direction.

The output device 650 may include a display 680, an audio output device 653, a notification device 655, and a haptic module 657.

The display 680 outputs and displays information processed by the mobile terminal 600.

As described above, when the display 680 forms a layered architecture with the touchpad to implement a touchscreen, the display 680 may be used not only as an output device but also as an input device for input of information according to user touch.

The audio output device 653 outputs audio data received from the wireless transceiver 610 or stored in the memory 660. The audio output device 653 may include a speaker and a buzzer.

The notification device 655 outputs a signal for reporting occurrence of an event in the mobile terminal 600. For example, the notification device 655 may output a signal in the form of vibration.

The haptic module 657 generates various haptic effects which may be felt by the user. A typical example of the haptic effects generated by the haptic module 657 is vibration.

The memory 660 may store a program for processing and control of the controller 670, and functions to temporarily store input data or output data (e.g., a phonebook, a message, a still image, a moving image, or the like).

The interface 625 serves as an interface for all devices connected to the mobile terminal 600. The interface 625 may serve to receive data or power from external devices and transfer the same to the internal constituents of the mobile terminal 600 and to transmit data from the mobile terminal 600 to external devices.

The controller 670 typically controls operations of the aforementioned respective elements, thereby controlling overall operation of the mobile terminal. For example, the controller 670 may perform control or processing related to voice communication, data communication, video communication, and the like. The controller 670 may also include a multimedia playback module 681 to reproduce multimedia. The multimedia playback module 681 may be provided in the controller 670 as hardware or may be configured separately from the controller 670.

The power supply 690 supplies power necessary for operations of the respective constituents according to control of the controller 670 when external power or internal power is applied thereto.

FIG. 6 is an internal block diagram of a server of FIG. 1.

Referring to the drawing, the server 700 according to an embodiment of the present disclosure includes: a transceiver 720 configured to exchange data with the image display apparatus 100 or the mobile terminal 600; a memory 740 configured to store viewing history information from the image display apparatus 100 or the mobile terminal 600; and a processor 770 configured to generate a program guide, including a combination of real-time content and non-real-time content, based on the viewing history information from the image display apparatus 100 or the mobile terminal 600.

The viewing history information may include real-time content information, viewing period of the real-time content, user information of the real-time content, device information on which the real-time content is played, non-real-time content information, viewing period of the non-real-time content, user information of the non-real-time content, device information on which the non-real-time content is played, and the like.

The real-time content information may include information on a network address of the real-time content, a title of the content, a start time of the content, and an end time of the content.

The non-real-time content information may include information on a network address of the non-real-time content, a title of the content, a start time of the content, and an end time of the content.

Meanwhile, the transceiver 720 transmits the generated program guide to the image display apparatus 100 or the mobile terminal 600. Accordingly, a custom program guide including the real-time content and the non-real-time content may be provided to the image display apparatus 100 or the mobile terminal 600.

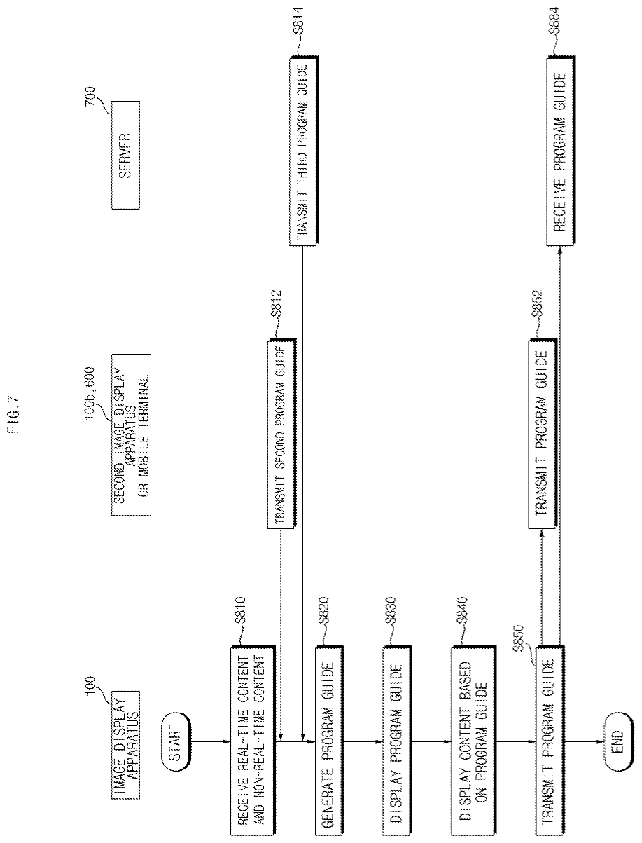

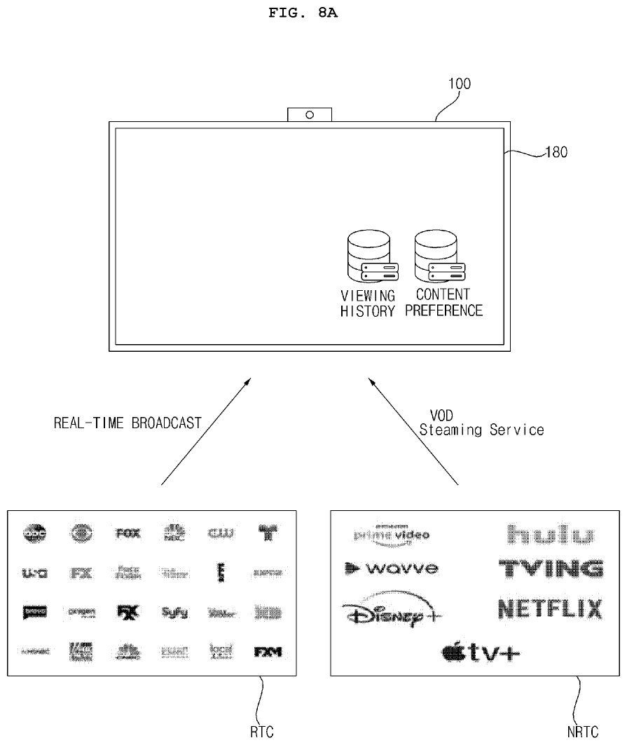

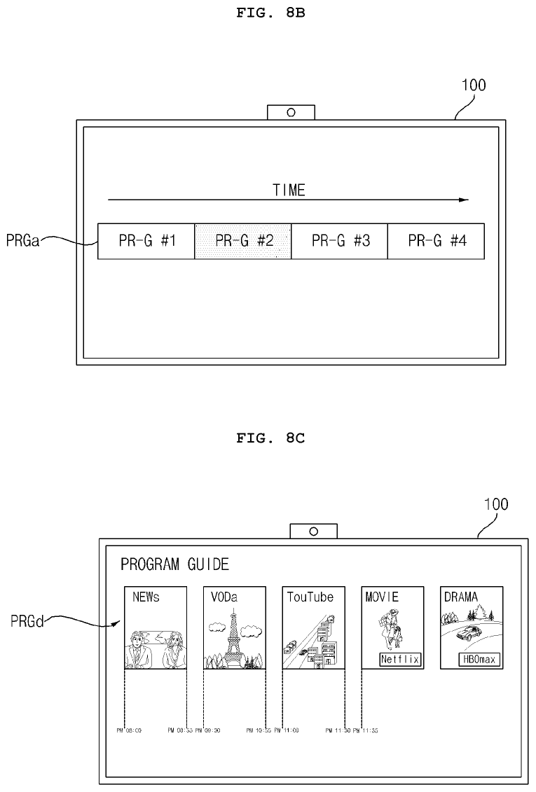

FIG. 7 is a flowchart illustrating a method of operating an image display apparatus according to an embodiment of the present disclosure.

Referring to the drawing, the content receiving device 105 in the image display apparatus 100 according to an embodiment of the present disclosure receives real-time content and non-real-time content from the external server 700 or the content provider 500 (S810).

For example, the content receiving device 105 in the image display apparatus 100 may receive real-time content information from the content provider 500 providing the real-time content.

The real-time content information may include start information of the real-time content, playback ending information of the real-time content, title information of the real-time content, detail information of the real-time content, and the like.

Meanwhile, the content receiving device 105 in the image display apparatus 100 may receive non-real-time content information from the server 700 providing the non-real-time content.

The non-real-time content information may include playback period information of the non-real-time information, title information of the non-real-time content, detail information of the non-real-time content, and the like.

The signal processing device 170 generates a program guide by combining the received real-time content information and non-real-time content information (S820).

Then, the signal processing device 170 may display the generated program guide on the display 180 (S830).

For example, the signal processing device 170 may generate the program guide by combining the real-time content and the non-real-time content based on a viewing history of the real-time content and a viewing history of the non-real-time content, and may display the generated program guide on the display 180. Accordingly, a custom program guide including the real-time content and the non-real-time content based on the viewing history may be provided.

Meanwhile, the signal processing device 170 may be trained based on the viewing history of the real-time content, the viewing history of the non-real-time content, and preference of the real-time content or the non-real-time content, may generate the program guide by combining the real-time content and the non-real-time content based on the learning, and may display the generated program guide on the display 180. Accordingly, a custom program guide, including the real-time content and the non-real-time content based on the learning, may be provided.

Meanwhile, the program guide includes a thumbnail image of each content and information of each content, and is classified by content or content source. Accordingly, a custom program guide including the real-time content and the non-real-time content may be provided.

Meanwhile, the information of each content may include information on the content provider 500, content title information, and content playback period information. Accordingly, a custom program guide including the real-time content and the non-real-time content may be provided.

Meanwhile, the signal processing device 170 may generate a program guide based on time information after power is turned on or after the end of playback of first content, start information of the real-time content, and playback period information of the non-real-time content, and may display the generated program guide on the display 180. Accordingly, a custom program guide including the real-time content and the non-real-time content may be provided.

Meanwhile, the signal processing device 170 may generate a program guide by assigning priority to scheduling information of the real-time content, of scheduling information of the real-time content and scheduling information of the non-real-time content, and may display the generated program guide on the display 180. Accordingly, a custom program guide may be provided in which priority is assigned to the real-time content, of the real-time content and the non-real-time content.

If a latest episode of the non-real-time content is uploaded, the signal processing device 170 may generate a program guide by assigning priority to the scheduling information of the non-real-time content, of the scheduling information of the real-time content and the scheduling information of the non-real-time content, and may display the generated program guide on the display 180. Accordingly, a custom program guide may be provided in which priority is assigned to the non-real-time content, of the real-time content and the non-real-time content.

Meanwhile, the signal processing device 170 may allocate non-real-time content information for a first user in the program guide during a first period and allocate real-time content information for a plurality of users in the program guide during a second period. Accordingly, a custom program guide including the real-time content and the non-real-time content may be provided.

Meanwhile, the signal processing device 170 may generate a program guide by using a second program guide from a second image display apparatus 100b or the mobile terminal 600.

For example, the second image display apparatus 100b or the mobile terminal 600 may transmit the second program guide to the image display apparatus 100 (S812).

In response thereto, the content receiving device 105 in the image display apparatus 100 may receive the second program guide, and the signal processing device 170 may generate a custom program guide, including the real-time content and non-real-time content, based further on the received second program guide.

Meanwhile, the signal processing device 170 may generate the program guide by using a third program guide from the server 700.

For example, the server 700 may transmit the third program guide to the image display apparatus 100 (S814).

In response thereto, the content receiving device 105 in the image display apparatus 100 may receive the third program guide, and the signal processing device 170 may generate a custom program guide, including the real-time content and non-real-time content, based further on the received third program guide.

Meanwhile, the signal processing device 170 may generate a program guide by using the second program guide from the second image display apparatus 100b or the mobile terminal 600, and the third program guide from the server 700.

Specifically, the content receiving device 105 in the image display apparatus 100 may receive the second program guide and the third program guide, and the signal processing device 170 may generate a custom program guide, including the real-time content and non-real-time content, based further on the received second and third program guides.

Meanwhile, the image display apparatus 100 according to an embodiment of the present disclosure may further include a camera 195 configured to capture an image, and the signal processing device 170 may generate a first program guide for a first user based on the image captured by the camera 195 or first log-in information, may generate a second program guide for a second user based on the image captured by the camera 195 or second log-in information, and may generate a third program guide for a plurality of users based on the image captured by the camera 195. Accordingly, a custom program guide including the real-time content and the non-real-time content may be provided for each user.

After operation 830 (S830), after the program guide is generated, the signal processing device 170 may combine the real-time content and non-real-time content and may display the content sequentially (S840) based on the generated program guide. Accordingly, content based on the custom program guide, including the real-time content and non-real-time content, may be provided.

Meanwhile, the signal processing device 170 may perform operation 820 (S820) while omitting operation 830 (S830) after operation 820 (S820).

For example, without displaying the generated program guide after generating the program guide, the signal processing device 170 may combine the real-time content and non-real-time content and display the content sequentially. Accordingly, content based on a custom program guide, including the real-time content and the non-real-time content, may be provided.

Meanwhile, the memory 140 in the image display apparatus 100 according to an embodiment of the present disclosure may store the generated program guide.

Further, after power of the image display apparatus 100 is turned on, the signal processing device 170 may combine the real-time content and non-real-time content and may display the content sequentially based on the program guide stored in the memory 140. Accordingly, content based on a custom program guide, including the real-time content and the non-real-time content, may be provided.

Meanwhile, the content receiving device 105 may transmit the generated program guide to the mobile terminal 600, another image display apparatus 100b, or the server 700 (S850).

For example, the content receiving device 105 may transmit the generated program guide to the second image display apparatus 100b or the mobile terminal 600. In response thereto, the second image display apparatus 100b or the mobile terminal 600 may receive the generated program guide.

Meanwhile, the second image display apparatus 100b or the mobile terminal 600 may combine the real-time content and the non-real-time content and display the content sequentially based on the received program guide.

Alternatively, the second image display apparatus 100b or the mobile terminal 600 may generate a separate program guide based on the received program guide, and may combine the real-time content and the non-real-time content and display the content sequentially based on the separately generated program guide. Accordingly, content based on a custom program guide, including the real-time content and the non-real-time content, may be provided.

In another example, the content receiving device 105 may transmit the generated program guide to the server 700. In response thereto, the server 700 may receive the generated program guide.

Meanwhile, the server 700 may generate a separate program guide based on the received program guide, and may transmit the separately generated program guide to another image display apparatus 100c or the mobile terminal 600, and the like. Accordingly, content based on a custom program guide, including the real-time content and the non-real-time content, may be provided.

Meanwhile, the signal processing device 170 of the image display apparatus 100 may manually generate a program guide according to a user input, or may automatically generate a program guide by analyzing a user's viewing pattern or usage pattern.

For example, based on the number of repeated views of different episodes of the same content, the signal processing device 170 of the image display apparatus 100 may generate a program guide by preferentially reflecting the corresponding content.

Meanwhile, if a live or real-time broadcast and VOD are on one channel, the signal processing device 170 of the image display apparatus 100 may generate a program guide in which a VOD time is adjusted.

Meanwhile, the signal processing device 170 of the image display apparatus 100 may generate a program guide in which scheduling information is reflected based on a viewer's viewing history of content and predicted preference.

Meanwhile, if first content information in the generated program guide is manually modified, the signal processing device 170 of the image display apparatus 100 may automatically adjust an order or sequence of the remaining content.

Meanwhile, if the program guide is manually modified after being automatically generated, the signal processing device 170 of the image display apparatus 100 may be trained to reflect the program guide in the automatic generation method.

For example, if the first content in the program guide is manually replaced after the program guide is automatically generated, the signal processing device 170 of the image display apparatus 100 may reflect a combination of a viewing condition and preferred content in training data.

In another example, if an order or sequence of content is manually adjusted after the program guide is automatically generated, the signal processing device 170 of the image display apparatus 100 may reflect information on whether to adjust the order for the real-time content, and a combination of viewing conditions and content characteristics, in the learning data.

Meanwhile, the signal processing device 170 of the image display apparatus 100 may generate a program guide in which scheduling information is readjusted based on pre-arranged scheduling information of the real-time content.

For example, based on the start time of the news, sports programs, and the like which are content items requiring real-time characteristics, the signal processing device 170 of the image display apparatus 100 may generate a program guide in which non-real-time content is scheduled between playback periods of the real-time content items.

Meanwhile, if the real-time content is scheduled before the non-real-time content is finished playing, the signal processing device 170 of the image display apparatus 100 may generate a program guide in which the real-time content is replaced with the non-real-time content.

Meanwhile, if the real-time content is scheduled before the non-real-time content is finished playing, the signal processing device 170 of the image display apparatus 100 may generate a program guide which is adjusted so that playback of the non-real-time content is stopped, and then is resumed after the real-time content is finished.

Meanwhile, the signal processing device 170 of the image display apparatus 100 may generate a program guide in which scheduling information is adjusted in response to an update of a new episode of a custom broadcast of the non-real-time content.

For example, if a new episode of a VOD content with a viewing history is released, the signal processing device 170 of the image display apparatus 100 may generate a program guide in which the new episode of the VOD is preferentially reflected.

Meanwhile, the signal processing device 170 of the image display apparatus 100 may generate a program guide in which another content, such as advertisement and the like, is inserted at a point between the end of the current content and next content, in the middle of content, or the like.

Meanwhile, the signal processing device 170 of the image display apparatus 100 may generate a program guide by considering a device that is aware of content information or capable of playing content.

For example, the signal processing device 170 of the image display apparatus 100 may replace content, which is unauthorized, inaccessible, or cannot be played, with another possible content.

Meanwhile, the signal processing device 170 of the image display apparatus 100 may generate a program guide based on a combination of two or more other program guides.

Meanwhile, the signal processing device 170 of the image display apparatus 100 may provide each of two or more other program guides for different channels, or may form the two or more program guides as one program guide by reflecting preference information and a user's viewing time information.

Meanwhile, the signal processing device 170 of the image display apparatus 100 may generate a program guide for family members by analyzing preference information of all family members and reflecting family viewing time of the members.

For example, the signal processing device 170 of the image display apparatus 100 may generate the program guide for family members in such a manner that, if there is only a first user among the family members in a first time period, the signal processing device 170 of the image display apparatus 100 may place content only for the first user in the first time period, and if there are all the family members in a second time period, the signal processing device 170 of the image display apparatus 100 may place content for all the family members in the second time period.

Meanwhile, while content is watched, the signal processing device 170 of the image display apparatus 100 may control the content to be played in an order designated by the program guide.

For example, content played based on the program guide may be synchronized with a user's viewing history, and if content was terminated while the user was watching the content, the content may be played from a point after the content is terminated, or a subsequent episode may be played if the user already watched the terminated episode.

Meanwhile, the signal processing device 170 of the image display apparatus 100 may share the generated program guide with another device.

For example, the device that shares the program guide may receive the program guide and use it immediately, or store the program guide for later use, or change or add content.

Meanwhile, the program guide may be accumulated and reprocessed by an external server to be retransmitted in the form of recommended scheduling information to each electronic device, such as the image display apparatus 100 or the mobile terminal 600.

Meanwhile, the signal processing device 170 of the image display apparatus 100 may directly transmit content while sharing the program guide.

For example, while sharing the program guide, the signal processing service 170 of the image display apparatus 100 may control a real-time image, captured by a camera, or content stored in the image display apparatus 100 to be transmitted along with the program guide.

In response thereto, another image display device 100b or the mobile terminal 600 and the like, which receives the real-time image, captured by the camera, or the content stored in the image display apparatus 100, may use the program guide and content immediately or store them for later use.

Meanwhile, if separate authentication or subscription is required for playback of content based on the program guide, the signal processing device 170 of the image display apparatus 100 may perform authentication or subscription procedures.

For example, the signal processing device 170 of the image display apparatus 100 may directly authenticate or subscribe to a content provider or a program provider, and may control a registration or payment process to take place.

Meanwhile, before subscription, registration, or payment, the signal processing device 170 of the image display apparatus 100 may control content to be received and displayed during a predetermined period of time.

Meanwhile, while sharing the program guide, the signal processing device 170 of the image display apparatus 100 may share the program guide with an electronic device used by friends, groups, celebrities, or the like.

Meanwhile, real-time content and non-real-time content in the program guide may include terrestrial broadcast, IPTV broadcast, OTT content, Cloud content, personal channel content, YouTube content, and the like.

Meanwhile, the signal processing device 170 of the image display apparatus 100 may generate a program guide by successively placing candidate content items at the beginning of operation of the image display apparatus 100 or at the beginning of service.

In this case, the signal processing device 170 of the image display apparatus 100 may first place the real-time content, and place the non-real-time content in between the real-time content items.

Meanwhile, while generating a program guide, if the real-time content is redundant, the signal processing device 170 of the image display apparatus 100 may adjust a playback time of content, which may be delayed in broadcast, among the real-time content items.

Meanwhile, the signal processing device 170 of the image display apparatus 100 may modify a content program schedule in the existing program guide, or suggest replacement with another content, or update the content to another content, based on viewing information of other users in the same time period or newly published information.

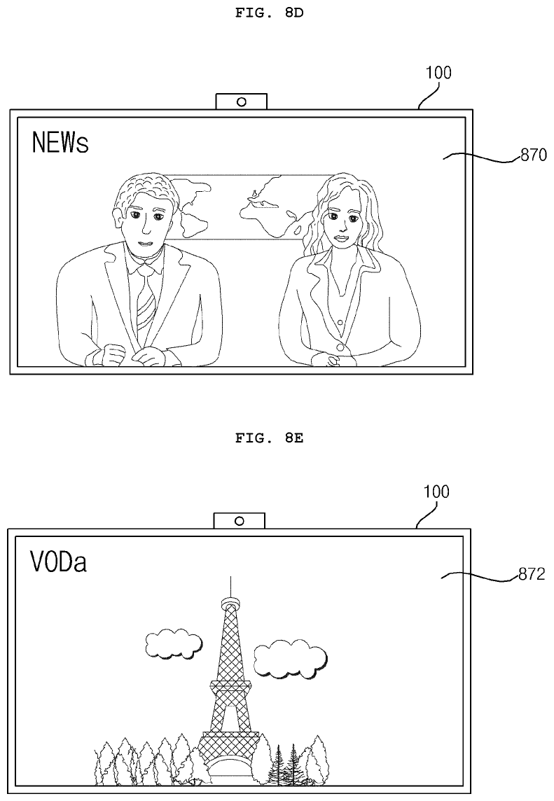

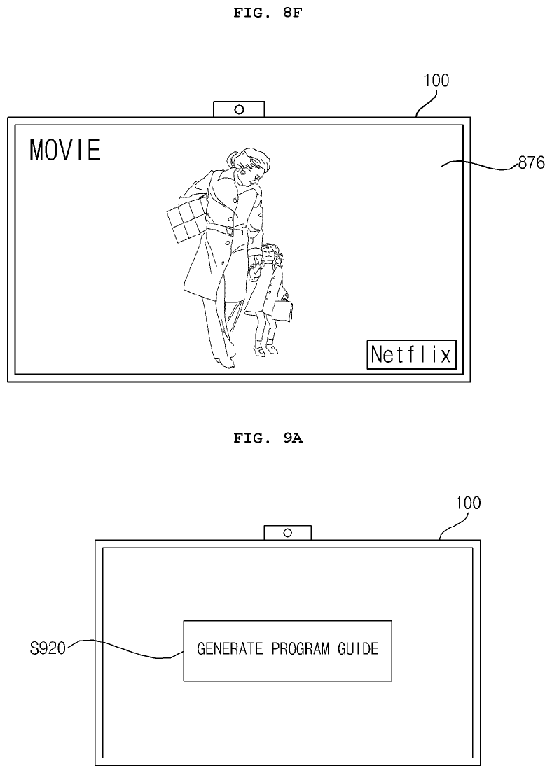

FIGS. 8A to 19B are diagrams referred to in the description of operation of FIG. 7.

FIG. 8A is a diagram illustrating an example in which real-time content RTC and non-real-time content NRTC are received by the image display apparatus 100.

Referring to the drawing, the real-time content RTC may be transmitted to the image display apparatus 100 from the server 510 of the content provider 500.

For example, the real-time content RTC may be live streaming video, live broadcast video, and the like.

Meanwhile, the non-real-time content NRTC may include video on demand (VOD) or streaming video on demand and the like from the server 700 of FIG. 1 and the like.

The content receiving device 105 in the image display apparatus 100 may receive information about the real-time content RTC and information about the non-real-time content NRTC, and the signal processing device 170 may generate a custom program guide based on a viewing history and preference of the real-time content RTC, a viewing history and preference of the non-real-time content NRTC, and the like.

Further, the content receiving device 105 in the image display apparatus 100 may display the generated custom program guide on the display 180.

FIG. 8B is a diagram illustrating an example of a generated program guide displayed on the display 180.

Referring to the drawing, a generated program guide PRGa may include, sequentially in chronological order, first real-time content PR-G #1, first non-real-time content PR-G #2, second real-time content PR-G #3, and third real-time content PR-G #4.

As illustrated in the drawing, the program guide PRGa includes the real-time content and non-real-time content, thereby providing a custom program guide.

Meanwhile, the program guide may include a thumbnail image of each content and information of each content, and may be classified by content or content source.

FIG. 8C is a diagram illustrating an example of a thumbnail-based program guide displayed on the display 180.

Referring to the drawing, a thumbnail-based program guide PRGd may include, sequentially in chronological order, first real-time content NEWs, first non-real-time content VODa, second non-real-time content TouTube, third non-real-time content MOVIE, and fourth non-real-time content DRAMA.

Meanwhile, as illustrated in the drawing, the thumbnail-based program guide PRGd may include start time information and end time information of at least one content.

Meanwhile, as described in the drawing, the thumbnail-based program guide PRGd may include source information, type information, or title information of each content.

As illustrated in the drawing, the thumbnail-based program guide PRGd includes the real-time content and non-real-time content, thereby providing a custom program guide.

Meanwhile, while FIG. 8C illustrates an example in which a rest period, during which real-time content or non-real-time content is not provided, is set between an end time of the first real-time content NEWs and a start time of the first non-real-time content VODa, but the rest period may vary.

For example, the rest period of 10 minutes or more or the rest period of less than 5 minutes may be set instead of 5 minutes as illustrated in the drawing.

Meanwhile, the signal processing device 170 may control advertisement content, which is separately received from the server 700 and the like, to be provided during the rest period.

Alternatively, the signal processing device 170 may control only audio, without any images, to be output during the rest period in consideration of a viewer's eye fatigue and the like. The audio provided in this case may be audio corresponding to the advertisement content.

Meanwhile, the signal processing device 170 may control the real-time content and non-real-time content to be sequentially generated and displayed according to the generated thumbnail-based program guide PRGd, which will be described below with reference to FIGS. 8D and 8F.

FIG. 8D is a diagram illustrating an example in which an image 870, corresponding to the first real-time content NEWs, is displayed on the display 180 at a first time.

Referring to the drawing, the signal processing device 170 be configured to automatically display the image 870 corresponding to the first real-time content NEWs at 8:00 p.m., which is the first time, according to the generated thumbnail-based program guide PRGd. Accordingly, the real-time content of the custom content may be provided in a simple manner.

FIG. 8E is a diagram illustrating an example in which an image 872, corresponding to the first non-real-time content VODa, is displayed on the display 180 at a second time.

Referring to the drawing, the signal processing device 170 may control the image 872, corresponding to the first non-real-time content VODa, to be displayed automatically at 9:00 p.m., which is the second time, according to the generated thumbnail-based program guide PRGd. Accordingly, the non-real-time content of the custom content may be provided in a simple manner.

FIG. 8F is a diagram illustrating an example in which an image 876, corresponding to the third non-real-time content MOVIE, is displayed on the display 180 at a third time.

Referring to the drawing, the signal processing device 170 may be configured to automatically display the image 876 corresponding to the third non-real-time content MOVIE at 11:00 p.m., which is the third time, according to the generated thumbnail-based program guide PRGd. Accordingly, the non-real-time content of the custom content may be provided in a simple manner.

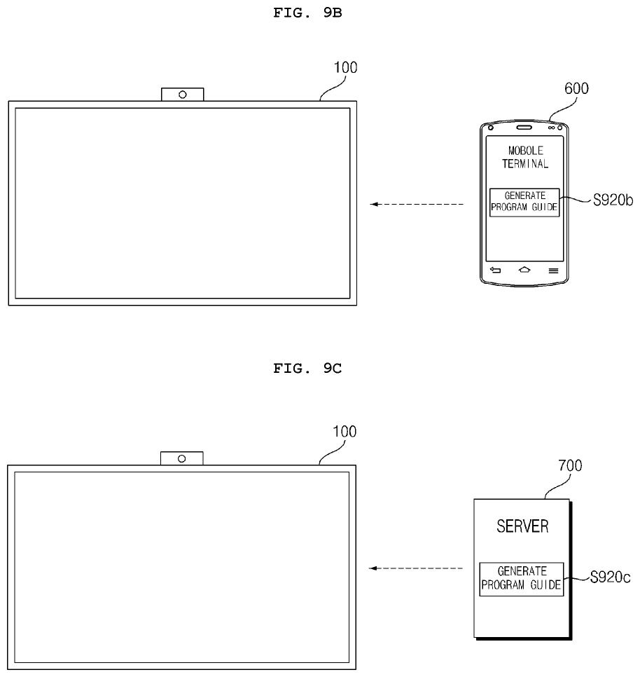

FIG. 9A is a diagram illustrating an example of generating a program guide by the image display apparatus 100.

Referring to the drawing, the signal processing device 170 in the image display apparatus 100 may generate a program guide by combining the received real-time content information and non-real-time content information.

FIG. 9B is a diagram illustrating an example of generating a program guide by a mobile terminal 600.

Referring to the drawing, a controller 680 in the mobile terminal 600 may generate a program guide by combining the received real-time content information and non-real-time content information.

Meanwhile, a program guide S920c generated by the mobile terminal 600 may be transmitted to the image display apparatus 100.

FIG. 9C is a diagram illustrating an example of generating a program guide by a server 700.

Referring to the drawing, based on viewing history information received from the image display apparatus 100 or the mobile terminal 600, the processor 770 in the server 700 may generate a program guide by combining the received real-time content and non-real-time content.

Meanwhile, the program guide S920c generated by the server 700 may be transmitted to the image display apparatus 100.

Meanwhile, the signal processing device 170 of the image display apparatus 100 may receive a second program guide, generated in FIG. 9B or FIG. 9C, from the mobile terminal 600 or the server 700, may generate a program guide based on the second program guide by combining the received real-time content information and non-real-time content information, and may display the generated program guide on the display 180. Accordingly, a custom program guide including the real-time content and the non-real-time content may be provided based on the second program guide received from an external source.

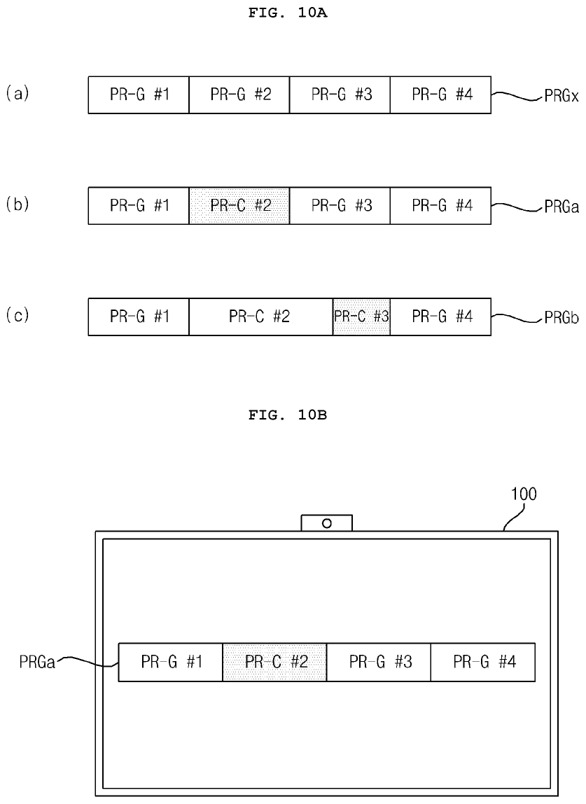

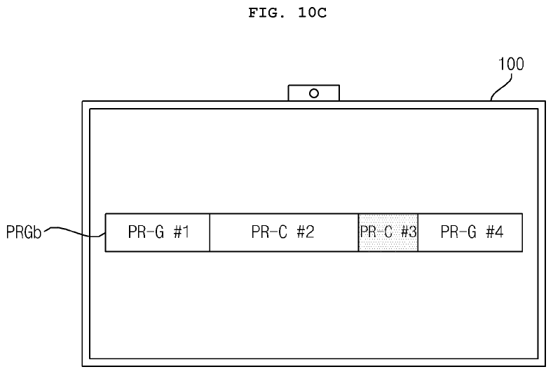

FIG. 10A is a diagram illustrating various examples of a program guide.

Referring to the drawing, a program guide RPGc of (a) of FIG. 10A may include, sequentially in chronological order, first real-time content PR-G #1, second real-time content PR-G #2, third real-time content PR-G #3, and fourth real-time content PR-G #4.

That is, the program guide RPGc of (a) of FIG. 10A includes only the real-time content items. However, when only the real-time content items are included without non-real-time content, such as VOD and the like, there is a drawback in that a program guide may not be provided for non-real-time content.

A program guide PRGa of (b) of FIG. 10A may include, sequentially in chronological order, first real-time content PR-G #1, first non-real-time content PR-G #2, second real-time content PR-G #3, and third real-time content PR-G #4.

Particularly, the first non-real-time content PR-G #2 may be placed between the first real-time content PR-G #1 and the second real-time content PR-G #3.

As illustrated in (b) of FIG. 10A, the signal processing device 170 according to an embodiment of the present disclosure generates the program guide PRGa including a combination of the real-time content and the non-real-time content, thereby providing a custom program guide including the real-time content and the non-real-time content.

A program guide PRGb of (c) of FIG. 10A may include, sequentially in chronological order, first real-time content PR-G #1, second real-time content PR-G #2, first non-real-time content PR-G #3, and third real-time content PR-G #4.

Particularly, the first non-real-time content PR-G #3 may be placed between the second real-time content PR-G #2 and the third real-time content PR-G #4.

As illustrated in (c) of FIG. 10A, the signal processing device 170 according to an embodiment of the present disclosure generates the program guide PRGb including a combination of the real-time content and the non-real-time content.

In the program guide PRGb of (c) of FIG. 10A, the first non-real-time content PR-G #3, which is playable in a short period of time between the second real-time content PR-G #2 and the third real-time content PR-G #4, is placed therebetween. Accordingly, a custom program guide including the real-time content and the non-real-time content may be provided.

FIG. 10B is a diagram illustrating an example of displaying the program guide PRGa of (b) of FIG. 10A on the display 180.

Referring to the drawing, the signal processing device 170 according to an embodiment of the present disclosure may be configured to display the generated program guide PRGa on the display 180. Accordingly, a custom program guide including the real-time content and the non-real-time content may be provided.

FIG. 10C is a diagram illustrating an example of displaying the program guide PRGb of (c) of FIG. 10A on the display 180.

Referring to the drawing, the signal processing device 170 according to an embodiment of the present disclosure may be configured to display the generated program guide PRGb on the display 180. Accordingly, a custom program guide including the real-time content and the non-real-time content may be provided.

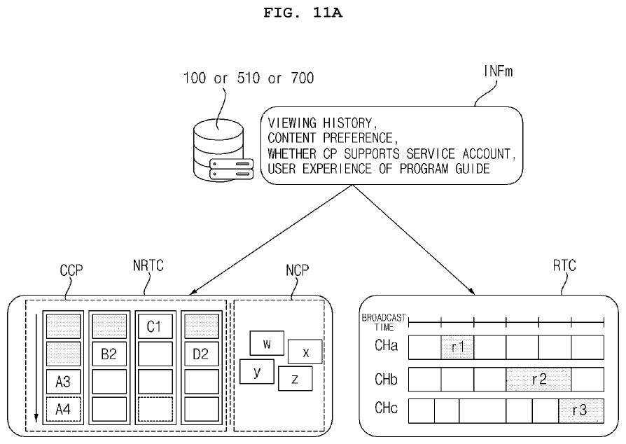

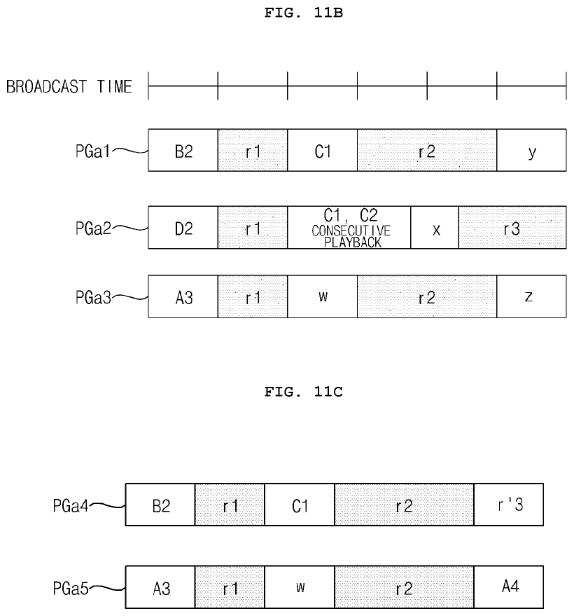

FIG. 11A is a diagram illustrating an example of generating a custom program guide including real-time content and non-real-time content.

Referring to the drawing, the server 510 of the content provider 500 or the server 700 may transmit information, such as viewing history and preference of content of the image display apparatus 100 or the mobile terminal 600, information on whether a content provider supports service account, user experience of a program guide, etc., to the image display apparatus 100 or the mobile terminal 600.

Based on the information, such as viewing history and content preference of the image display apparatus 100 or the mobile terminal 600, information on whether a content provider supports service account, user experience of a program guide, etc., the signal processing device 170 of the image display apparatus 100 may divide non-real-time program candidates NRTC and real-time program candidates RTC for generating a program guide.

The non-real-time program candidates NRTC may include continuous content CCCP non-continuous content NCP.

In the drawing, an example is illustrated in which the continuous content CCCP is classified into four categories A, B, C, and D and classified as A1-A4, B1-B2, C1, and D1-D2 based on episode information.

The signal processing device 170 of the image display apparatus 100 may generate the non-real-time program candidates NRTC, while excluding previously viewed content items from A1-A4, B1-B2, C1, and D1-D2 in the continuous content CCCP.

For example, if A1-A2, B1, and D1 are previously viewed content items among A1-A4, B1-B2, C1, and D1-D2, the signal processing device 170 of the image display apparatus 100 may include A3-A4, B2, C1, and D2 as the continuous content CCCP in the non-real-time program candidates NRTC, while excluding A1-A2, B1, and D1.

Meanwhile, the non-continuous content NCP may include w, x, y, and z as illustrated in the drawing.

The signal processing device 170 of the image display apparatus 100 may divide the real-time program candidates RTC into a plurality of content sources.

In the drawing, a plurality of broadcast channels CHa to CHc are illustrated as the real-time program candidates RTC, and thus, the real-time content may be divided into the plurality of broadcast channels CHa to CHc.

Further, in the drawing, first real-time content r1 of a first channel CHa, second real-time content r2 of a second channel CHb, and third real-time content r3 of a third channel CHc are illustrated as the real-time program candidates RTC.

In this case, a broadcast time of the first real-time content r1 of the first channel CHa does not overlap with a broadcast time of the second real-time content r2 of the second channel CHb, but a broadcast time of the second real-time content r2 of the second channel CHb may partially overlap with a broadcast time of the third real-time content r3 of the third channel CHc.

As described above, if the broadcast time of the second real-time content r2 and the broadcast time of the third real-time content r3 partially overlap, the signal processing device 170 of the image display apparatus 100 may generate a program guide by including only one of the second real-time content r2 and the third real-time content r3 therein.

Meanwhile, based on a viewing history or content preference and the like in a scheduling guide for the plurality of broadcast channels CHa to CHc, the signal processing device 170 of the image display apparatus 100 may extract only specific program content and may generate the extracted program content as the real-time program candidates RTC.

As described above, the signal processing device 170 of the image display apparatus 100 may generate the first program r1 of the first channel CHa, the second program r2 of the second channel CHb, and the third program r3 of the third channel CHc as the real-time program candidates RTC.

FIG. 11B is a diagram illustrating an example of generating various program guides based on non-real-time program candidates NRTC and real-time program candidates RTC.

Referring to the drawing, the signal processing device 170 of the image display apparatus 100 may generate a first program guide PGa1 which sequentially includes first non-real-time continuous content B1, first real-time content r1, second non-real-time continuous content C1, second real-time content r2, and first non-real-time non-continuous content y.

As described, by placing the first real-time content r1 between the first non-real-time continuous content B1 and the second non-real-time continuous content C1, and placing the second real-time content r2 between the second non-real-time continuous content C1 and the first non-real-time non-continuous content y, a user may view content continuously or seamlessly.

Meanwhile, the signal processing device 170 of the image display apparatus 100 may generate a second program guide PGa2 which sequentially includes first non-real-time continuous content D2, first real-time content r1, second non-real-time continuous content C1, third non-real-time continuous content C2, first non-real-time non-continuous content x, and second real-time content r3.

Particularly, the signal processing device 170 of the image display apparatus 100 may control the second non-real-time continuous content C1 and the third non-real-time continuous content C2 to be played consecutively.

As described above, by placing the first real-time content r1 between the first non-real-time continuous content D2 and the second non-real-time continuous content C1, and placing the first non-real-time non-continuous content x between the third non-real-time continuous content C2 and the second real-time content r3, a user may view content continuously or seamlessly.

Meanwhile, the signal processing device 170 of the image display apparatus 100 may generate a third program guide PGa3 which sequentially includes first non-real-time continuous content A3, first real-time content r1, first non-real-time non-continuous content w, second real-time content r2, and second non-real-time non-continuous content z.

As described above, by placing the first real-time content r1 between the first non-real-time continuous content A3 and the first non-real-time non-continuous content w, and placing the second real-time content r2 between the first non-real-time non-continuous content w and the second non-real-time non-continuous content z, a user may view content continuously or seamlessly.

Meanwhile, if there is content, which may be delayed in playback, of the real-time content and the non-real-time content in the program guide, the signal processing device 170 may change a playback time of the content which may be delayed in playback. Accordingly, during playback of content, a playback time of the content may change based on a custom program guide including the real-time content and non-real-time content, which will be described below with reference to FIG. 11C.

FIG. 11C is a diagram illustrating another example of generating various program guides based on non-real-time program candidates NRTC and real-time program candidates RTC.

Referring to the drawing, the signal processing device 170 of the image display apparatus 100 may generate a fourth program guide PGa4, in which a playback time of a second real-time content r3 is delayed, based on the second program guide PGa2 of FIG. 11B.

As described above, if the broadcast time of the second real-time content r2 and the broadcast time of the third real-time content r3 partially overlap, the signal processing device 170 of the image display apparatus 100 may generate a program guide by including only one of the second real-time content r2 and the third real-time content r3 therein.

For example, even when the broadcast time of the first real-time content r2 and the broadcast time of the second real-time content r3 partially overlap, the signal processing device 170 of the image display apparatus 100 checks whether it is possible to delay broadcast of the second real-time content r3, and if it is possible to delay the broadcast, the signal processing device 170 of the image display apparatus 100 may generate the fourth program guide PGa4 in which a playback time of the second real-time content r3 is delayed. Accordingly, it is possible to prevent broadcast times of two real-time content items from overlapping each other in the program guide.

Meanwhile, the signal processing device 170 of the image display apparatus 100 may generate a fifth program guide PGa4, including second non-real-time continuous content A4 instead of the second non-real-time non-continuous content z, based on the third program guide PGa3 of FIG. 11B.

For example, if the second non-real-time continuous content A4 is newly updated after the third program guide PGa3 is generated, the signal processing device 170 of the image display apparatus 100 may delete the second non-real-time non-continuous content z by assigning priority to the second non-real-time continuous content A4, and may generate a fifth program guide PGa5 including the second non-real-time continuous content A4 instead of the deleted content.

Meanwhile, if a latest episode of non-real-time content is uploaded, the signal processing device 170 may generate a program guide by assigning priority to scheduling information of the non-real-time content, of scheduling information of the real-time content and scheduling information of the non-real-time content, and may be configured to display the generated program guide on the display 180. Accordingly, a custom program guide may be provided in which priority is assigned to the non-real-time content, of the real-time content and the non-real-time content.

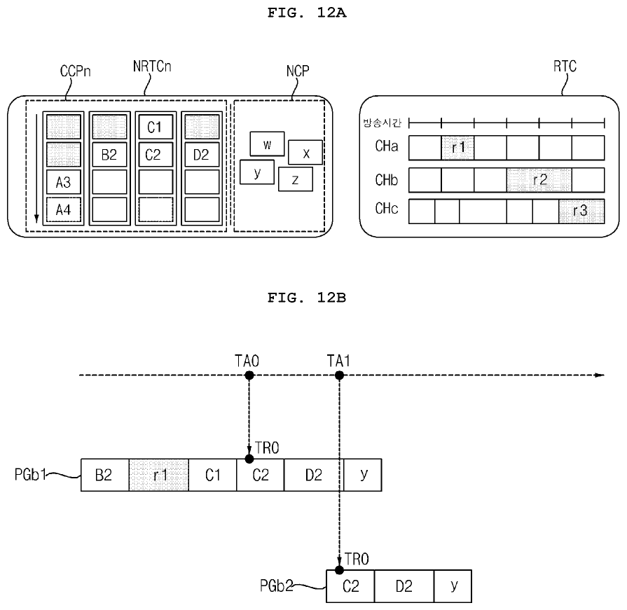

FIG. 12A is a diagram illustrating an example of second non-real-time program candidates NRTCn and real-time program candidates RTC.

Referring to the drawing, the second non-real-time program candidates NRTCn may include second continuous content CCPn and non-continuous content NCP.

In the drawing, an example is illustrated in which the second continuous content CCPn is classified into four categories A, B, C, and D and classified as A1-A4, B1-B2, C1-C2, and D1-D2 based on episode information.

The signal processing device 170 of the image display apparatus 100 may generate the second non-real-time program candidates NRTCn, while excluding previously viewed content items from A1-A4, B1-B2, C1-C2, and D1-D2 in the second continuous content CCPn.

For example, if A1-A2, B1, and D1 are previously viewed content items among A1-A4, B1-B2, C1-C2, and D1-D2, the signal processing device 170 of the image display apparatus 100 may include A3-A4, B2, C1-C2, and D2 as the second continuous content CCPn in the second non-real-time program candidates NRTCn, while excluding A1-A2, B1, and D1.

Meanwhile, the real-time program candidates RTC may be divided into a plurality of broadcast channels CHa to CHc.

That is, as illustrated in the drawing, the signal processing device 170 of the image display apparatus 100 may generate a first program r1 of a first channel CHa, a second program r2 of a second channel CHb, and a third program r3 of a third channel CHc as the real-time program candidates RTC.

The signal processing device 170 of the image display apparatus 100 may update the program guide based on a viewing time, which will be described below with reference to FIG. 12B.

FIG. 12B is a diagram illustrating an example of generating various program guides based on second non-real-time program candidates NRTCn and real-time program candidates RTC.

Referring to the drawing, the signal processing device 170 of the image display apparatus 100 may generate a first program guide PGb1 which sequentially includes first non-real-time continuous content B2, first real-time content r1, second non-real-time continuous content C1, third non-real-time continuous content C2, fourth non-real-time continuous content D2, and first non-real-time non-continuous content y.

While the non-real-time content is played based on the program guide, if playback of the content is terminated at a specific time during playback, the signal processing device 170 of the image display apparatus 100 may store a playback stop point.

Further, if the non-real-time content, which stops playing, is played again, the signal processing device 170 of the image display apparatus 100 may update the program guide and may control the content to be played according to the updated program guide.

Specifically, while first non-real-time continuous content B2, first real-time content r1, second non-real-time continuous content C1, and third non-real-time continuous content C2 are played sequentially, if playback thereof is terminated at a first time TA0 during playback, the signal processing device 170 of the image display apparatus 100 may store a playback stop point TRO of the third non-real-time continuous content C2 being played.

Then, if the first non-real-time continuous content C2 is played at a second time TA1, the signal processing device 170 of the image display apparatus 100 may control playback of the content to resume from the playback stop point TRO.

In addition, the signal processing device 170 of the image display apparatus 100 may update the program guide after the second time TA1.

In the drawing, as there is no real-time content after the second time TA1 in the first program guide PGb1, the signal processing device 170 of the image display apparatus 100 may generate a second program guide PGb2 which sequentially includes first non-real-time continuous content C2, second non-real-time continuous content D2, and first non-real-time non-continuous content y.

In another example, if there is real-time content after the second time TA1 in the first program guide PGb1, the signal processing device 170 of the image display apparatus 100 may change an arrangement order in the program guide based on the real-time content.

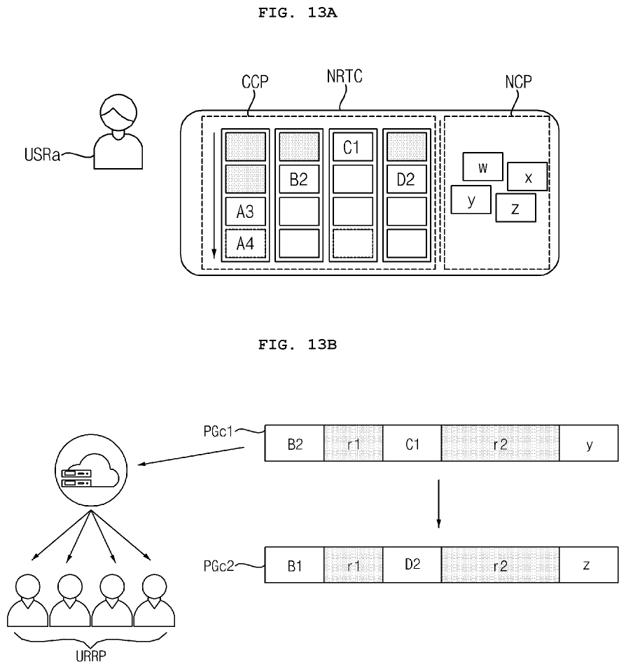

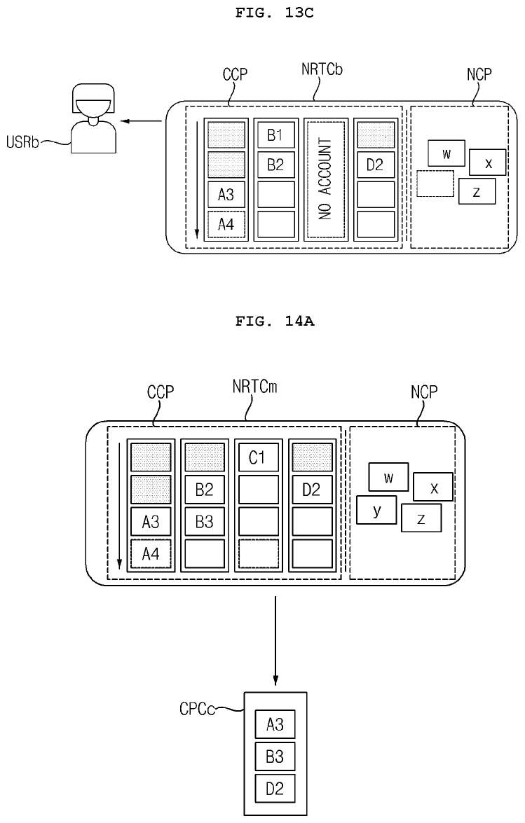

FIGS. 13A to 13C are diagrams referred to in the description of an example of sharing and updating a program guide.

FIG. 13A is a diagram illustrating an example of non-real-time program candidates NRTC for a first user USRa as illustrated in FIG. 11.

Referring to the drawing, the non-real-time program candidates NRTC for the first user USRa may be the same as the non-real-time program candidates NRTC of FIG. 11A.

FIG. 13B is a diagram illustrating an example of a program guide based on the non-real-time program candidates NRTC.

Referring to the drawing, the signal processing device 170 of the image display apparatus 100 may generate a first program guide PGc1 for the first user USRa by using the non-real-time program candidates NRTC of FIG. 13A and the real-time program candidates RTC of FIG. 11A.

The first program guide PGc1 for the first user USRa may sequentially include first non-real-time continuous content B2, first real-time content r1, second non-real-time continuous content C1, second real-time content r2, and first non-real-time non-continuous content y.

FIG. 13C is a diagram illustrating an example of non-real-time program candidates NRTCb for a second user USRb.

Referring to the drawing, the non-real-time program candidates NRTCb for the second user USRb may be divided into continuous content CCCP and non-continuous content NCP.

In the drawing, an example is illustrated in which the continuous content CCCP is classified into three categories A, B, and C, and unlike FIG. 13A, there is no account for content C.

That is, the continuous content CCCP of FIG. 13C is illustrated as A1-A4, B1-B2, and D1-D2, among which A1-A2 and D1 are previously viewed content items, such that the signal processing device 170 of the image display apparatus 100 may include A3-A4, B1-B2, and D2 as the continuous content CCCP in the non-real-time program candidates NRTC, while excluding the previously viewed content items A1-A2 and D1.

Meanwhile, unlike FIG. 11A, FIG. 13C illustrates w, x, and z as non-continuous content items, while excluding content y as non-continuous content.

Accordingly, the signal processing device 170 of the image display apparatus 100 may generate a second program guide PGc2 for the second user USRb, by using A3-A4, B1-B2, and D2 in the non-real-time program candidates NRTC and w, x, and z in the non-continuous content NCP.

As illustrated in FIG. 13B, the second program guide PGc2 for the second user USRb may sequentially include first non-real-time continuous content B1, first real-time content r1, second non-real-time continuous content D2, second real-time content r2, and first non-real-time non-continuous content z.

In comparison of the first program guide PGc1 for the first user USRa with the second program guide PGc2 for the second user USRb, B2 is replaced with B1 as the first non-real-time continuous content, C1 is replaced with D2 as the second non-real-time continuous content, and y is replaced with z as the first non-real-time non-continuous content.

Meanwhile, as illustrated in FIG. 13B, the signal processing device 170 of the image display apparatus 100 may transmit, through the content receiving device 105, the first program guide PGc1 for the first user USRa and the second program guide PGc2 for the second user USRb to the external server 700 or the content provider 500 or another image display apparatus 100b or the mobile terminal 600, etc., to share the program guide.

Accordingly, programs guides generated by other users or other electronic devices may be used.

Meanwhile, referring to FIGS. 13B and 13C, the signal processing device 170 receives a second program guide from the mobile terminal 600 or the server 510 or 700, and if there is no access right to the first content (e.g., content C1 of FIG. 13C) in the second program guide, the signal processing device 170 replaces the first content C1 with the second content D2, generates a program guide based on the replaced second content, and may be configured to display the generated program guide on the display 180. Accordingly, a custom program guide including real-time content and non-real-time content may be provided in consideration of the access right to content.

Meanwhile, referring to FIGS. 13B and 13C, if content requires authentication, the signal processing device 170 may exclude the content from the program guide and may control another content to be included therein. Accordingly, a custom program guide including real-time content and non-real-time content may be provided in consideration of the authentication.

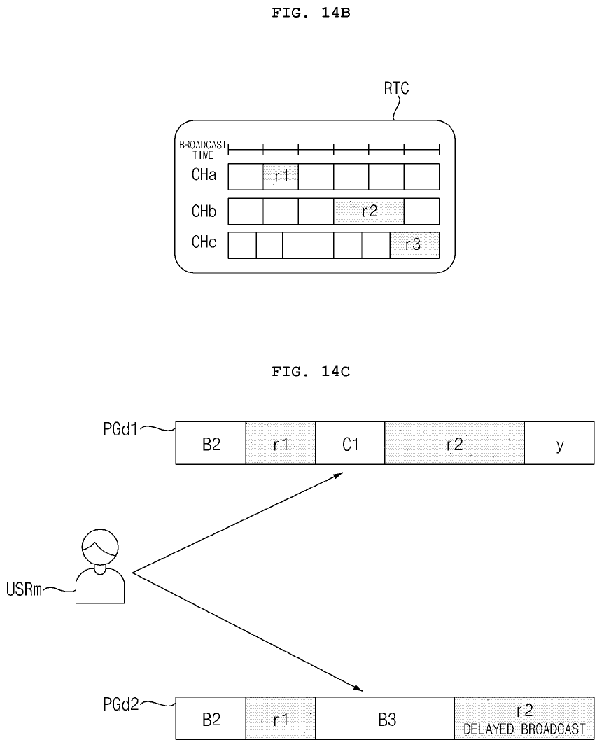

FIGS. 14A to 14C are diagrams referred to in the description of an example of editing a program guide.

FIG. 14A is a diagram illustrating an example of non-real-time program candidates NRTCm.

Referring to the drawing, the non-real-time program candidates NRTCm may include continuous content CCCP and non-continuous content NCP.

The continuous content CCCP is classified into four categories A, B, C, and D, and classified as A1-A4, B1-B3, C1, and D1-D2 based on episode information.

Meanwhile, the signal processing device 170 of the image display apparatus 100 may generate the non-real-time program candidates NRTC, while excluding previously viewed content items from A1-A4, B1-B3, C1, and D1-D2 in the continuous content CCCP.

For example, if A1-A2, B1, and D1 are previously viewed content items among A1-A4, B1-B3, C1, and D1-D2, the signal processing device 170 of the image display apparatus 100 may include A3-A4, B2-B3, C1, and D2 as the continuous content CCCP in the non-real-time program candidates NRTC, while excluding A1-A2, B1, and D1.

Meanwhile, the non-continuous content NCP may include w, x, y, and z, as illustrated in the drawing.

Meanwhile, the signal processing device 170 of the image display apparatus 100 may generate modified program candidates CPCc based on the non-real-time program candidates NRTCm.

For example, the signal processing device 170 of the image display apparatus 100 may generate the modified program candidates CPCc by using the continuous content or non-continuous content in the non-real-time program candidate NRTCm.

In the drawing, an example is illustrated in which the modified program candidates CPCc include A3, B3, and D2fmf.

FIG. 14B is a diagram illustrating an example of the real-time program candidates RTC.

Referring to the drawing, the real-time program candidates RTC may include first real-time content r1 of a first channel CHa, second real-time content r2 of a second channel CHb, and third real-time content r3 of a third channel CHc.

In this case, a broadcast time of the first real-time content r1 of the first channel CHa does not overlap with a broadcast time of the second real-time content r2 of the second channel CHb, but the broadcast time of the second real-time content r2 of the second channel CHb may partially overlap with a broadcast time of the third real-time content r3 of the third channel CHc.

FIG. 14C is a diagram illustrating an example of editing a generated program guide.

Referring to the drawing, the signal processing device 170 of the image display apparatus 100 may generate a program guide PGd1 for the first user USRa based on the real-time program candidates NRTCm of FIG. 14A and the real-time program candidates RTC of FIG. 14B.

In the drawing, an example is illustrated in which the program guide PGd1 sequentially includes first non-real-time continuous content B2, first real-time content r1, second non-real-time continuous content C1, second real-time content r2, and first non-real-time non-continuous content y.

The signal processing device 170 of the image display apparatus 100 may edit or update the generated program guide PGd1 based on the modified program candidates CPCc.

In this case, the signal processing device 170 of the image display apparatus 100 checks whether it is possible to delay broadcast of the real-time content in the program guide PGd1, and if it is possible to delay the broadcast, the signal processing device 170 may edit or update the generated program guide PGd1 so that the corresponding real-time content may be delayed in playback.

In the drawing, the edited or updated program guide PGd2 sequentially includes first non-real-time continuous content B2, first real-time content r1, second non-real-time continuous content B3, and second real-time content r2.

Particularly, in the edited or updated program guide PGd2, the second non-real-time continuous content C1 is replaced with the second non-real-time continuous content B3, and due to the replacement with the second non-real-time continuous content B3, a playback period increases, but broadcast of the second real-time content r2 may be delayed, such that the second real-time content r2 may be set to be delayed in broadcast. Accordingly, a user may watch a latest series of content, while delaying broadcast of the real-time content.

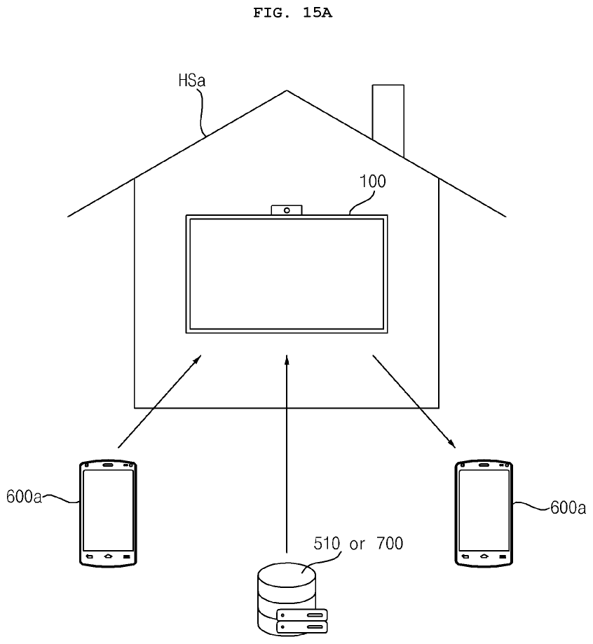

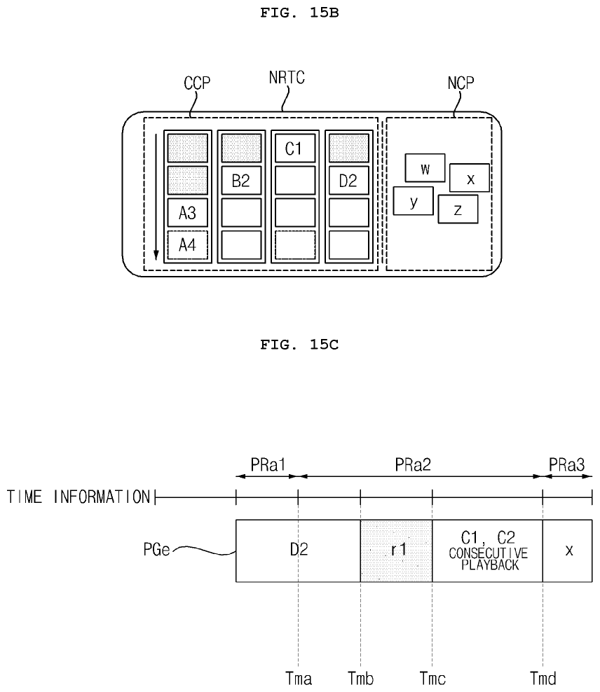

FIGS. 15A to 15C are diagrams illustrating an example of seamless playback of content in a program guide by using a plurality of electronic devices.

FIG. 15A is a diagram illustrating the image display apparatus 100, two mobile terminals 600b and 600a, and the server 510 or 700.

Referring to the drawing, when first content is played on a first mobile terminal 600a located outside a building HSa, and then the first mobile terminal 600a moves into the building HSa, the signal processing device 170 of the image display apparatus 100 may control the first content to be played seamlessly on the image display apparatus 100 inside the building HSa based on the program guide.

Meanwhile, the signal processing device 170 of the image display apparatus 100 may control subsequent content to be played after playback of the first content is finished, based on the program guide.

Meanwhile, if the first mobile terminal 600a moves out of the building HSa while the subsequent content is played, the signal processing device 170 of the image display apparatus 100 may control the subsequent content to be played seamlessly on the first mobile terminal 600a, based on the program guide. Accordingly, content may be played seamlessly on various electronic devices based on the program guide.

FIG. 15B is a diagram illustrating non-real-time program candidates NRTC.

Referring to the drawing, the non-real-time program candidates NRTC may include continuous content CCCP and non-continuous content NCP.

The continuous content CCCP is classified into four categories A, B, C, and D, and classified as into A1-A4, B1-B2, C1, and D1-D2 based on episode information.

Meanwhile, the signal processing device 170 of the image display apparatus 100 may generate the non-real-time program candidates NRTC, while excluding previously viewed content items from A1-A4, B1-B2, C1, and D1-D2 in the continuous content CCCP.

For example, if A1-A2, B1, and D1 are previously viewed content items among A1-A4, B1-B2, C1, and D1-D2, the signal processing device 170 of the image display apparatus 100 may include A3-A4, B2, C1, and D2 as the continuous content CCCP in the non-real-time program candidates NRTC, while excluding A1-A2, B1, and D1.

Meanwhile, the non-continuous content NCP may include w, x, y, and z, as illustrated in the drawing.

FIG. 15C is a diagram explaining seamless playback based on a program guide.

Referring to the drawing, the signal processing device 170 of the image display apparatus 100 may generate a program guide PGe based on the non-real-time program candidates NRTC of FIG. 15B and the real-time content RTC of FIG. 11A.

In the drawing, the generated program guide PGe sequentially includes first non-real-time continuous content D2, first real-time content r1, second non-real-time continuous content C1 and third non-real-time continuous content C3 which are consecutively played, and first non-real-time non-continuous content x.

Meanwhile, based on the program guide PGe, the first non-real-time continuous content D2, the first real-time content r1, the second non-real-time continuous content C1 and third non-real-time continuous content C3 which are consecutively played, and the first non-real-time non-continuous content x may be played sequentially.

Meanwhile, the first mobile terminal 600a located outside the building HSa may play the first non-real-time continuous content D2.

If the first mobile terminal 600a moves into the building HSa at a first time Tma while playing the first non-real-time continuous content D2, the first mobile terminal 600a terminates playback of the first non-real-time continuous content D2, and the image display apparatus 100 may seamlessly play the first non-real-time continuous content D2.

The first mobile terminal 600a and the image display apparatus 100 may share the program guide PGe.

For example, if the first mobile terminal 600a moves into the building HSa at the first time Tma, the first mobile terminal 600a and the image display apparatus 100 are paired, and after the pairing is complete, the first mobile terminal 600a terminates playback of the first non-real-time continuous content D2, and the image display apparatus 100 may seamlessly play the first non-real-time continuous content D2.

That is, the first mobile terminal 600a may play the first non-real-time continuous content D2 only during a first period PRa1.

Meanwhile, based on the program guide PGe, the image display apparatus 100 may finish playback of the first non-real-time continuous content D2 at a second time Tmb, and may play the first real-time content r1.

Then, based on the program guide PGe, the image display apparatus 100 may finish playback of the first real-time content r1 at a third time Tmc, and may consecutively play the second non-real-time continuous content C1 and third non-real-time continuous content C3.

Meanwhile, based on the program guide PGe, the image display apparatus 100 may finish consecutive playback of the second non-real-time continuous content C1 and third non-real-time continuous content C3 at a fourth time Tmd.

Meanwhile, based on the program guide PGe, the image display apparatus 100 may play a portion of the first non-real-time continuous content D2, the first real-time content r1, the second non-real-time continuous content C1, and the third non-real-time continuous content C3 during a second period PRa2.

Meanwhile, when the first mobile terminal 600a moves out of the building HSa at the fourth time Tmd, pairing between the first mobile terminal 600a and the image display apparatus 100 is terminated.

Accordingly, after the pairing is terminated, the signal processing device 170 of the image display apparatus 100 terminates playback of content based on the program guide PGe and controls the first mobile terminal 600a to resume playing content based on the program guide PGe.

In the drawing, an example is illustrated in which the first non-real-time non-continuous content x is played on the first mobile terminal 600a during a third period PRa3 after the fourth time Tmd, thereby allowing seamless playback of content on various electronic devices.

Meanwhile, as illustrated in FIG. 15A, when the first mobile terminal 600a and the image display apparatus 100 share the program guide PGe, content items accessible by the first mobile terminal 600a and the image display apparatus 100 may not be the same but different from each other. In this case, the program guide PGe may be changed to content accessible by the first mobile terminal 600a or the image display apparatus 100.

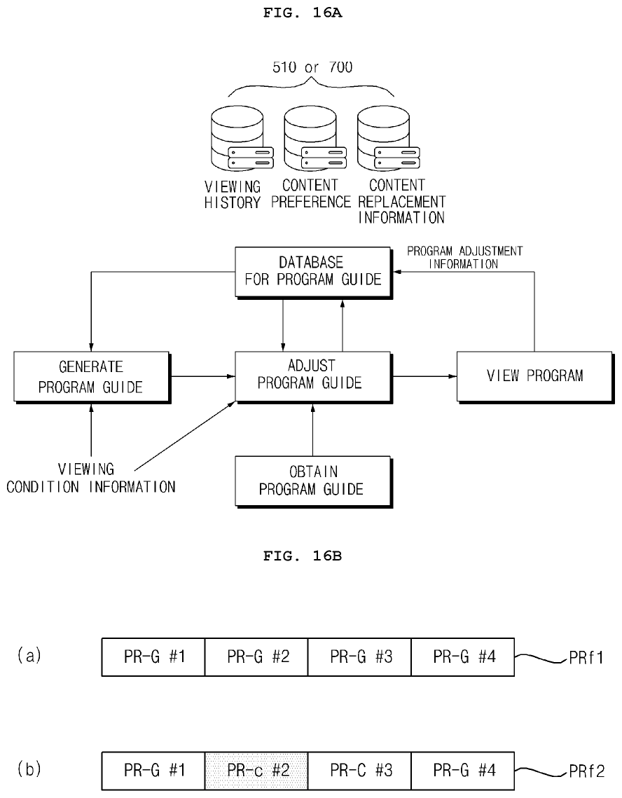

FIG. 16A is a diagram referred to in the description of operation of the server 510 or 700, and FIG. 16B is a diagram referred to in the description of FIG. 16A.

Referring to FIG. 16A, the server 510 or 700 may receive a variety of information from at least one image display apparatus 100 or the mobile terminal 600.

In this case, the variety of information may include a viewing history of real-time content and a viewing history of non-real-time content, preference of the real-time content, preference of the non-real-time content, replacement information of the real-time content, replacement information of the non-real-time content, viewing conditions of the real-time content, viewing conditions of the non-real-time content, and the like.

Further, the processor 770 in the server 510 or 700 may form a database for generating a program guide by analyzing the received variety of information.

For example, the processor 770 in the server 510 or 700 may generate a program guide based on viewing condition information.

In this case, the viewing condition information may include a viewing time, a place, the number of viewers indicating whether a viewer watches content alone or together with other viewers, viewer information indicating who a viewer is, type information of a viewing device, and the like.

Meanwhile, as illustrated in FIG. 16B, the processor 770 in the server 510 or 700 may adjust a program guide to be viewed, based on a program guide PRf1 received from the at least one image display apparatus 100 or the mobile terminal 600, and may generate an adjusted program guide PRf2.

In the drawing, an example is illustrated in which the received program guide PRf1 sequentially includes first content PR-G #1, second content PR-G #2, third content PR-G #3, and fourth content PR-G #4.

For example, based on a database for a program guide, the processor 770 in the server 510 or 700 may automatically or manually adjust the received program guide.

Meanwhile, the processor 770 in the server 510 or 700 may be trained in combination with the viewing condition information, and based on the learning, content replacement information may be reflected in the database.

Meanwhile, if the program guide is manually adjusted, the processor 770 in the server 510 or 700 may generate the adjusted program guide PRf2 by replacing the second content PR-G #2 in the received program guide PRf1 with the second content PR-C#2.

Meanwhile, while viewing the content, if a user changes the content to another content (e.g., another channel or program) and views the content for a predetermined period of time, the processor 770 in the server 510 or 700 may reflect content preference information and content replacement information in the database.

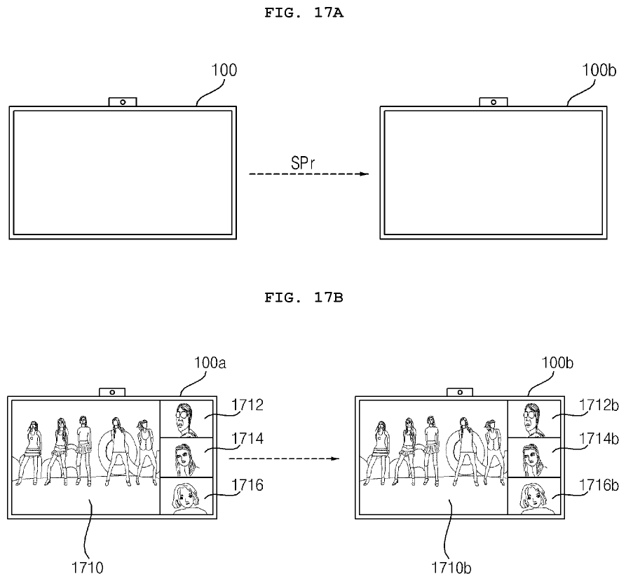

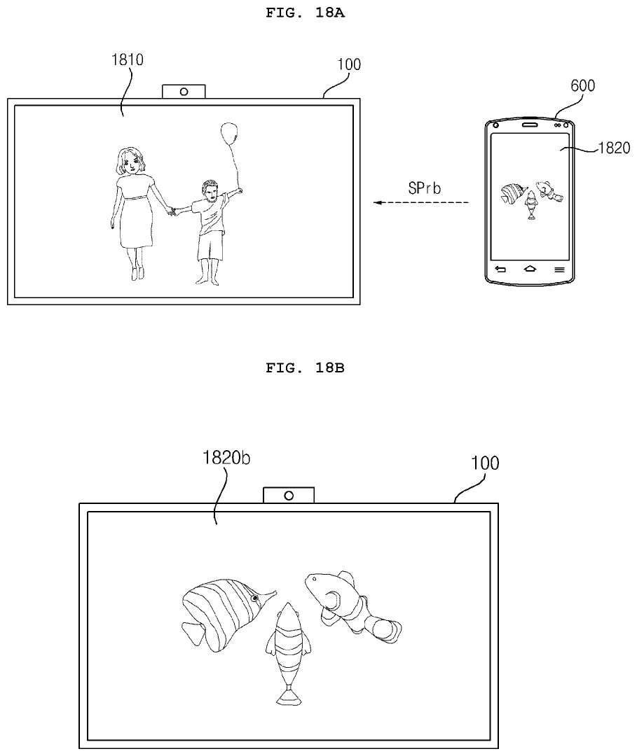

FIGS. 17A and 17B are diagram illustrating an example in which a program guide Spr is shared among a plurality of image display apparatuses.

First, FIG. 17A illustrates an example in which a first image display apparatus 100a transmits a program guide, including real-time content and non-real-time content, to a second image display apparatus 100b through a network and the like.

Accordingly, the second image display apparatus 100b may receive the program guide Spr and may display related content based on the program guide Spr.

Meanwhile, the program guide Spr, which is generated in the first image display apparatus 100a, may be shared by another image display apparatus other than the second image display apparatus 100b.

Meanwhile, the signal processing device 170 in the first image display apparatus 100a may be configured to display a video chatting screen, including images captured by the camera 195 and images captured by another mobile terminal 600 or another image display apparatus 100b, along with a content screen. Accordingly, video chatting based on a custom program guide, including real-time content and non-real-time content, may be provided.

FIG. 17B illustrates an example in which images 1710 and 1710b of first content are displayed on the first image display apparatus 100a and the second image display apparatus 100b based on the program guide Spr.

In this case, the image display apparatus 100a and the second image display apparatus 100b may transmit images, captured by their own camera 195, to each other.

Accordingly, the first image display apparatus 100a and the second image display apparatus 100b may display images 1712, 1714, 1712b, and 1714b, captured by their own camera, along with the images 1710 and 1710b of the first content. Accordingly, while watching the first content, a user may share information about the first content through the video chatting screen and the like.

Meanwhile, if a third image display apparatus (not shown) also shares the program guide Spr in addition to the first image display apparatus 100a and the second image display apparatus 100b, the first image display apparatus 100a and the second image display apparatus 100b may receive images captured by a camera of the third image display apparatus (not shown).

Further, the first image display apparatus 100a and the second image display apparatus 100b may display images 1716 and 1716b, captured by the camera of the third image display apparatus (not shown), along with the images 1710 and 1710b of the first content. Accordingly, while viewing the first content, a user may share information about the first content through a video chatting screen and the like.

FIGS. 18A and 18B are diagrams illustrating an example in which a program guide Sprb is shared between the image display apparatus 100 and the mobile terminal 600.

First, FIG. 18A illustrates an example in which the mobile terminal 600 transmits the program guide Sprb, including real-time content and non-real-time content, to the image display apparatus 100 through a network and the like.

Accordingly, the image display apparatus 100 may receive the program guide Sprb and may display related content based on the program guide Sprb.

Particularly, as illustrated in FIG. 18A, while displaying a first image 1810, if the image display apparatus 100 receives the program guide Sprb from the mobile terminal 600, the signal processing device 170 of the image display apparatus 100 may be configured to display a content image, which is the same as a content image 1820 displayed on the mobile terminal 600, on the image display apparatus 100.

FIG. 18B is a diagram illustrating an example in which a content image 1820b, which is the same as the content image 1820 displayed on the mobile terminal 600, is displayed on the image display apparatus 100, thereby allowing seamless playback and display of content by sharing the program guide Spbr.

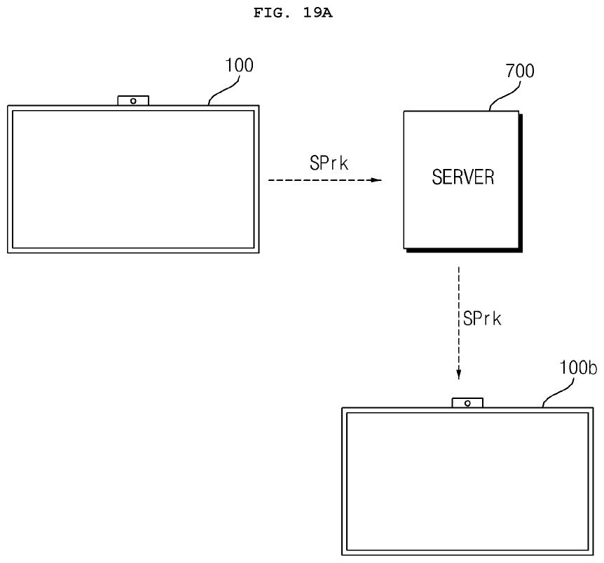

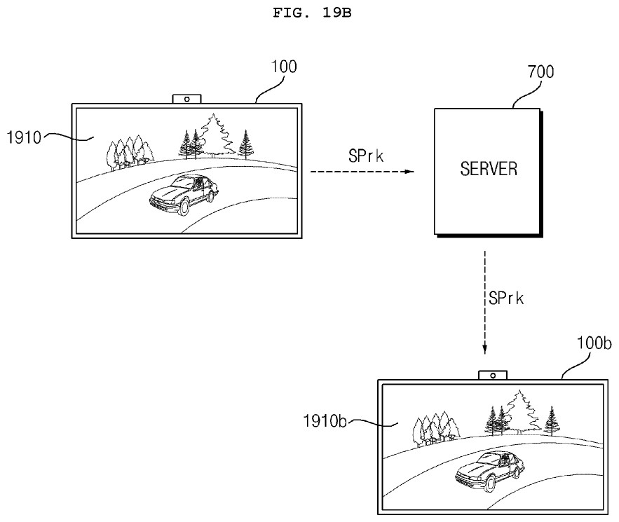

FIGS. 19A and 19B are diagrams illustrating an example of sharing a program guide Sprk between a plurality of image display apparatuses 100 and 100b via the server 700.

First, FIG. 19A illustrates an example in which the image display apparatus 100 transmits the program guide Sprk to the server 700, and the server 70 transmits the program guide Sprk to the second image display apparatus 100b.

Accordingly, as illustrated in FIG. 19B, the image display apparatus 100 may display an image 1910 related to the first content based on the program guide Sprk, and the second image display apparatus 100b may also display an image 1910b related to the first content based on the program guide Sprk.

Although preferred embodiments of the present disclosure have been illustrated and described above, the present disclosure is not limited to the specific embodiments described above, various modifications can be made by those skilled in the art to which the invention pertains without departing from the gist of the present disclosure claimed in claims, and these modified embodiments should not be individually understood from the technical idea or perspective of the present disclosure.

What is claimed is:

1. An image display apparatus comprising:
a display;
a content receiving device configured to receive real-time content or non-real-time content from an external server or a content provider; and
a signal processing device configured to generate a program guide by combining the real-time content and the non-real-time content which are received by the content receiving device, and to display the generated program guide on the display or display the content based on the generated program guide.

2. The image display apparatus of claim 1, wherein after generating the program guide, the signal processing device is configured to combine the real-time content and the non-real-time content and to display the content sequentially based on the generated program guide.

3. The image display apparatus of claim 1, further comprising a memory configured to store the generated program guide,
wherein after power is turned on, the signal processing device is configured to combine the real-time content and the non-real-time content and to display the content sequentially based on the generated program guide.

4. The image display apparatus of claim 1, wherein the signal processing device is configured to generate the program guide by combining the real-time content and the non-real-time content based on a viewing history of the real-time content and a viewing history of the non-real-time content, and to display the generated program guide on the display.

5. The image display apparatus of claim 1, wherein the signal processing device is configured to perform learning based on the viewing history of the real-time content, the viewing history of the non-real-time content, and preference of the real-time content or the non-real-time content, to generate the program guide by combining the real-time content and the non-real-time content based on the learning, and to display the generated program guide on the display.

6. The image display apparatus of claim 1, wherein the program guide comprises a thumbnail image of each content and information of each content,
wherein the program guide is classified by content or content source.

7. The image display apparatus of claim 6, wherein the information of the each content comprises content provider information, content title information, and content playback time information.

8. The image display apparatus of claim 1, wherein the signal processing device is configured to generate the program guide based on time information after power is turned on or after playback of first content is terminated, start information of the real-time content, and playback period information of the non-real-time content, and to display the generated program guide on the display.

9. The image display apparatus of claim 1, wherein the signal processing device is configured to generate the program guide by assigning priority to scheduling information of the real-time content, of scheduling information of the real-time content and scheduling information of the non-real-time content, and to display the generated program guide on the display.

10. The image display apparatus of claim 1, wherein in response to a latest episode of the non-real-time content being uploaded, the signal processing device is configured to generate the program guide by assigning priority to the scheduling information of the non-real-time content, of the scheduling information of the real-time content and the scheduling information of the non-real-time content, and to display the generated program guide on the display.

11. The image display apparatus of claim 1, wherein the signal processing device is configured to:
allocate non-real-time content information for a first user in the program guide during a first period; and
allocate real-time content information for a plurality of users in the program guide during a second period following the first period.

12. The image display apparatus of claim 1, further comprising a camera configured to capture an image,
wherein the signal processing device is configured to:
based on the image captured by the camera or first log-in information, generate a first program guide for the first user;
based on the image captured by the camera or second log-in information, generate a second program guide for the second user; and
based on the image captured by the camera, generate a third program guide for a plurality of users.

13. The image display apparatus of claim 1, wherein the signal processing device is configured to transmit the generated program guide to a mobile terminal, another image display apparatus, or the server.

14. The image display apparatus of claim 1, further comprising a camera,
wherein after transmitting the generated program guide to an external device, the signal processing device is configured to display a video chatting screen along with a content screen, wherein the video chatting screen includes the image captured by the camera and an image captured by another mobile terminal or another image display apparatus.

15. The image display apparatus of claim 1, wherein the signal processing device is configured to receive the second program guide from a mobile terminal or the server, to generate a program guide by combining the second program guide and the received real-time content information and non-real-time content information, and to display the generated program guide on the display.

16. The image display apparatus of claim 1, wherein the signal processing device is configured to receive the second program guide from a mobile terminal or the server, and in response to there being no access right to the first content in the second program guide, the signal processing device is configured to replace the first content with second content, to generate a program guide based on the replaced second content, and to display the generated program guide on the display.

17. The image display apparatus of claim 1, wherein in response to content capable of being delayed in playback being included in the real-time content or the non-real-time content in the program guide, the signal processing device is configured to perform control so that a playback time of the content capable of being delayed in playback, changes.

18. The image display apparatus of claim 1, wherein in response to requiring content authentication, the signal processing device is configured to exclude the content from the program guide and include another content to the program guide.

19. An image display apparatus comprising:
a display;
a content receiving device configured to receive a program guide, including a combination of real-time content and non-real-time content, from an external mobile terminal or a server, or to receive real-time content or non-real-time content from the server or a content provider; and
a signal processing device configured to display the real-time content or the non-real-time content based on the program guide received by the content receiving device.

20. A server comprising:
a transceiver configured to exchange data with an image display apparatus or a mobile terminal;
a memory configured to store viewing history information from the image display apparatus or the mobile terminal; and
a processor configured to generate a program guide including a combination of real-time content information and non-real-time content information based on the viewing history information from the image display apparatus or the mobile terminal,
wherein the transceiver is configured to transmit the generated program guide to the image display apparatus or the mobile terminal.
